(19) United States
(12) Patent Application Publication
(10) Pub. No.: US 2025/0227710 A1
(43) Pub. Date: Jul. 10, 2025

(54) COMMUNICATIONS DEVICES, NETWORK NODES, CIRCUITRY, SYSTEMS AND METHODS

(71) Applicant: Sony Group Corporation, Tokyo (JP)

(72) Inventor: Shin Horng WONG, Basingstoke (GB)

(73) Assignee: Sony Group Corporation, Tokyo (JP)

(21) Appl. No.: 18/693,751

(22) PCT Filed: Sep. 14, 2022
(86) PCT No.: PCT/EP2022/075583

§ 371 Date: Mar. 20, 2024

(30) Foreign Application Priority Data
Sep. 30, 2021 (EP) 21200312.3

(51) Int. Cl. H04W 72/23; H04W 72/1263; H04W 76/27

(52) U.S. Cl. CPC H04W 72/23; H04W 72/1263; H04W 76/27

(57) ABSTRACT

A method for use in a mobile communications network comprising identifying, by a network node and in a first set of downlink transmissions to be transmitted to the communications device, the last N downlink transmissions; transmitting, by the network node, the first set of downlink transmissions to the communications device wherein transmitting the last N downlink transmissions comprises providing an Ending Grant Indicator “EGI” in association with each of the N downlink transmissions; receiving, by the communications device, downlink transmissions of the first set of downlink transmissions; identifying, by the communications device, any received downlink transmissions of the first set of downlink transmissions that is associated with an EGI; determining, by the communications device and based on the identification of the any received downlink transmissions associated with an EGI, whether the communications device has missed one or more downlink transmissions.

### CROSS-REFERENCE TO RELATED APPLICATIONS

This application is a national stage application, pursuant to 35 U.S.C. § 371, of International Patent Application No. PCT/EP2022/075583, filed Sep. 14, 2022, which claims priority from European Patent Application No. 21200312.3, filed Sep. 30, 2021, the entire contents of each are incorporated herein by reference.

### FIELD

The present disclosure relates to communications devices, network nodes, circuitry, systems and methods. Examples of the present disclosure can be particularly useful for transmitting and/or receiving acknowledgements in a mobile telecommunications network.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems are able to support a wider range of services than simple voice and messaging services offered by earlier generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to efficiently support communications with an ever-increasing range of devices and data traffic profiles than existing systems are optimised to support. For example, it is expected future wireless communications networks will be expected to efficiently support communications with devices including reduced complexity devices, machine type communications devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of a desire to support new types of devices with a variety of applications there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

Example use cases currently considered to be of interest for next and latest generation wireless communication systems include so-called Ultra Reliable and Low Latency Communications (URLLC)/enhanced Ultra Reliable and Low Latency Communications (eURLLC). See, for example, the 3GPP documents RP-160671, “New SID Proposal: Study on New Radio Access Technology,” NTT DOCOMO, RAN #71 [1]; RP-172834, “Work Item on New Radio (NR) Access Technology,” NTT DOCOMO, RAN #78 [2]; RP-182089, “New SID on Physical Layer Enhancements for NR Ultra-Reliable and Low Latency Communication (URLLC),” Huawei, HiSilicon, Nokia, Nokia Shanghai Bell, RAN #81 [3]; and RP-190654, “Physical layer enhancements for NR ultra-reliable and low latency communication (URLLC),” Huawei, HiSilicon, RAN #89, Shenzhen, China, 18 to 21 Mar. 2019 [4].

URLLC services are low latency and high reliability services (e.g. to support applications such as factory automation, transport industry, electrical power distribution etc.). URLLC services might, for example, aim to transmit data through a radio network with a target 32-byte packet transit time (i.e. time from ingress of a layer 2 packet to its egress from the network) of 1 ms (i.e. so that each packet needs to be scheduled and transmitted across the physical layer in a time that is shorter than 1 ms) with 99.999% reliability within the 1 ms target packet transit time [5], and 99.9999% with a latency between 0.5 ms and 1 ms.

The 3GPP project has recently completed a Release-16 Work Item on eURLLC [6] to specify features that require high reliability and low latency such as factory automation, transport industry, electrical power distribution, etc. in a 5G system. The eURLLC feature is further enhanced in Release-17 in a Work Item [7], where one of the objectives is to enhance acknowledgment signalling (HARQ-ACK feedback) in respect of URLLC downlink transmissions.

Application EP 20187799.0 filed 24 Jul. 2020 [10], the contents of which are incorporated herein by reference, also provides techniques for managing acknowledgement messages and may be of interest to the skilled reader.

### SUMMARY

The invention is defined in the independent claims. Further example embodiments are provided in the dependent claims.

According to a first aspect, there is provided a method for use in a mobile communications network comprising a network node and a communications device, the network node being configured to provide a wireless interface to communicate with the communications device, the method comprising identifying, by the network node and in a first set of downlink transmissions to be transmitted to the communications device, the last N downlink transmissions where N is greater than or equal to 1; transmitting, by the network node, the first set of downlink transmissions to the communications device wherein transmitting the last N downlink transmissions comprises providing an Ending Grant Indicator “EGI” in association with each of the N downlink transmissions; receiving, by the communications device, downlink transmissions of the first set of downlink transmissions; identifying, by the communications device, any received downlink transmissions of the first set of downlink transmissions that is associated with an EGI; determining, by the communications device and based on the identification of the any received downlink transmissions associated with an EGI, whether the communications device has missed one or more downlink transmissions; and transmitting, by the communications device, acknowledgement information to the network node based on the determination of whether one or more downlink transmissions have been missed.

According to another aspect, there is provided a system for communicating in a mobile communications network comprising a network node and a communications device, the network node being configured to provide a wireless interface to communicate with the communications device, wherein the network node is configured to: identify, in a first set of downlink transmissions to be transmitted to the communications device, the last N downlink transmissions where N is greater than or equal to 1, and transmit the first set of downlink transmissions to the communications device wherein transmitting the last N downlink transmissions comprises providing an Ending Grant Indicator “EGI” in association with each of the N downlink transmissions; and wherein the communications device is configured to: receive downlink transmissions of the first set of downlink transmissions, identify any received downlink transmissions of the first set of downlink transmissions that is associated with an EGI, determine, based on the identification of the any received downlink transmissions associated with an EGI, whether the communications device has missed one or more downlink transmissions, and transmit acknowledgement information to the network node based on the determination of whether one or more downlink transmissions have been missed.

According to a further aspect, there is provided a method of operating a network node in a mobile communications network comprising the network node and a communications device, the network node being configured to provide a wireless interface to communicate with the communications device, wherein method comprises identifying, in a first set of downlink transmissions to be transmitted to the communications device, the last N downlink transmissions where N is greater than or equal to 1; and transmitting the first set of downlink transmissions to the communications device wherein transmitting the last N downlink transmissions comprises providing an Ending Grant Indicator “EGI” in association with each of the N downlink transmissions.

According to yet another aspect, there is provided a network node for use in a mobile communications network comprising the network node and a communications device, the network node being configured to provide a wireless interface to communicate with the communications device, wherein the network node is further configured to: identify, in a first set of downlink transmissions to be transmitted to the communications device, the last N downlink transmissions where N is greater than or equal to 1; and transmit the first set of downlink transmissions to the communications device wherein transmitting the last N downlink transmissions comprises providing an Ending Grant Indicator “EGI” in association with each of the N downlink transmissions.

According to a further aspect, there is provided circuitry for a network node for use in a mobile telecommunications network, the network comprising the network node and a communications device, the network node being configured to provide a wireless interface to communicate with the communications device, wherein the circuitry comprises a controller element and a transceiver element configured to operate together to communicate with the communications device via the wireless interface and wherein the controller element and the transceiver element are further configured to operate together to: identify, in a first set of downlink transmissions to be transmitted to the communications device, the last N downlink transmissions where N is greater than or equal to 1; and transmit the first set of downlink transmissions to the communications device wherein transmitting the last N downlink transmissions comprises providing an Ending Grant Indicator “EGI” in association with each of the N downlink transmissions.

According to another aspect, there is provided a method of operating a communications device for use in a mobile communications network comprising a network node and the communications device, the network node being configured to provide a wireless interface to communicate with the communications device, the method comprising: receiving downlink transmissions of a first set of downlink transmissions; identifying any received downlink transmissions of the first set of downlink transmissions that is associated with an Ending Grant Indicator “EGI” provided by the network node; determining, based on the identification of the any received downlink transmissions associated with an EGI, whether the communications device has missed one or more downlink transmissions, and transmitting acknowledgement information to the network node based on the determination of whether one or more downlink transmissions have been missed.

According to yet another aspect, there is provided a communications device for use in a mobile communications network comprising a network node and the communications device, the network node being configured to provide a wireless interface to communicate with the communications device, wherein the communications device is configured to: receive downlink transmissions of a first set of downlink transmissions; identify any received downlink transmissions of the first set of downlink transmissions that is associated with an Ending Grant Indicator “EGI” provided by the network node; determine, based on the identification of the any received downlink transmissions associated with an EGI, whether the communications device has missed one or more downlink transmissions, and transmit acknowledgement information to the network node based on the determination of whether one or more downlink transmissions have been missed.

According to an additional aspect, there is provided circuitry for a communications device for use in a mobile telecommunications network, the network comprising a network node and the communications device, the network node being configured to provide a wireless interface to communicate with the communications device, wherein the circuitry comprises a controller element and a transceiver element configured to operate together to communicate with the communications device via the wireless interface and wherein the controller element and the transceiver element are further configured to operate together to: receive downlink transmissions of a first set of downlink transmissions; identify any received downlink transmissions of the first set of downlink transmissions that is associated with an Ending Grant Indicator “EGI” provided by the network node; determine, based on the identification of the any received downlink transmissions associated with an EGI, whether the communications device has missed one or more downlink transmissions, and transmit acknowledgement information to the network node based on the determination of whether one or more downlink transmissions have been missed.

It is to be understood that both the foregoing general description and the following detailed description are illustrative, but are not restrictive, of the present technology. The described examples devices, systems or methods of the present disclosure, together with associated teachings, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an example LTE-type wireless telecommunication network;

FIG. 2 schematically represents some aspects of an example new radio (NR) access technology (RAT) wireless telecommunications network;

FIG. 3 schematically represents an example telecommunications system;

FIGS. 4 to 8 schematically show example uses of radio resources associated with a communications device in an uplink grid of radio communications resources (top half of figure) and downlink grid of radio communications resources (bottom half of figure);

FIGS. 9 to 14 schematically show example uses of radio resources associated in accordance with the examples of the present disclosure; and

FIG. 15 illustrates an example method in accordance with the present disclosure.

In the following description, reference is made to the accompanying drawings which illustrate several examples of the present disclosure. It is to be understood that other examples may be implemented and system or method changes may be made without departing from the teachings of the present disclosure. The following detailed description is not to be taken in a limiting sense, and the scope of the embodiments of the present invention is defined only by the claims. It is to be understood that drawings are not necessarily drawn to scale. Some examples of the present disclosure may not fall within the scope of the claims but are useful for understanding the technical field of the invention and the teachings of the present disclosure.

### DESCRIPTION OF EXAMPLES

### Long Term Evolution Advanced Radio Access Technology (4G)

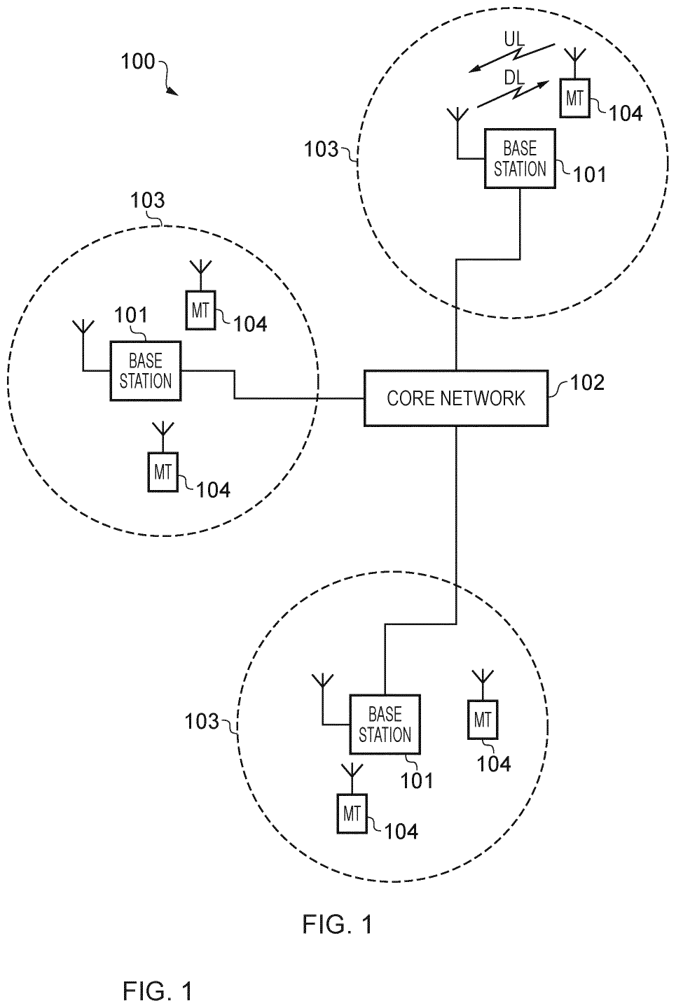

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [9]. It will be appreciated that operational aspects of the telecommunications (or simply, communications) networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network 102. Each base station provides a coverage area 103 (i.e. a cell) within which data can be communicated to and from terminal devices 104. Data is transmitted from base stations 101 to terminal devices 104 within their respective coverage areas 103 via a radio downlink (DL). Data is transmitted from terminal devices 104 to the base stations 101 via a radio uplink (UL). The core network 102 routes data to and from the terminal devices 104 via the respective base stations 101 and provides functions such as authentication, mobility management, charging and so on. Terminal devices may also be referred to as mobile stations, user equipment (UE), user terminal, mobile radio, communications device, and so forth. Base stations, which are an example of network infrastructure equipment/network access node, may also be referred to as transceiver stations/nodeBs/e-nodeBs/eNBs/g-nodeBs/gNBs and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

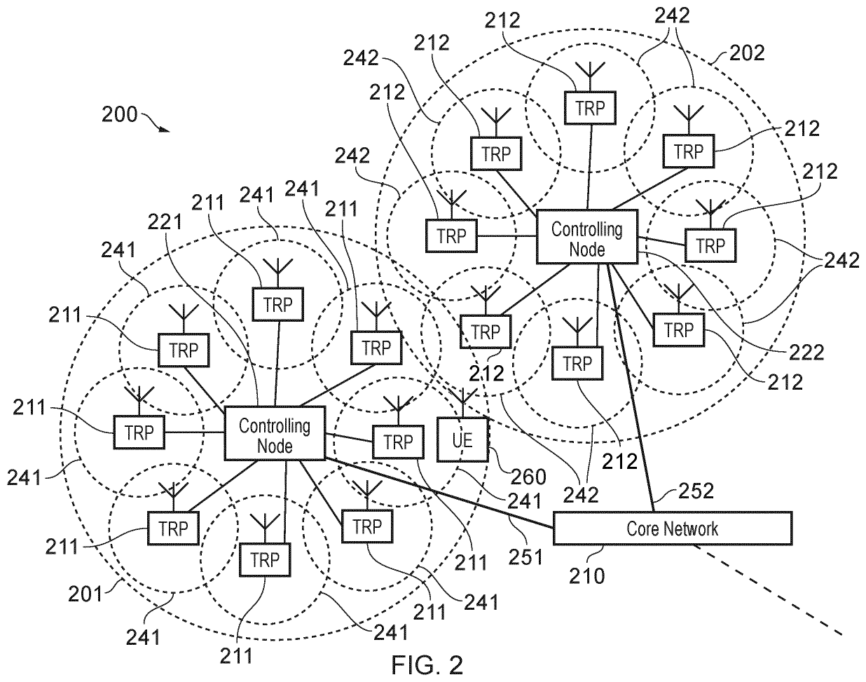

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units (DUs) 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

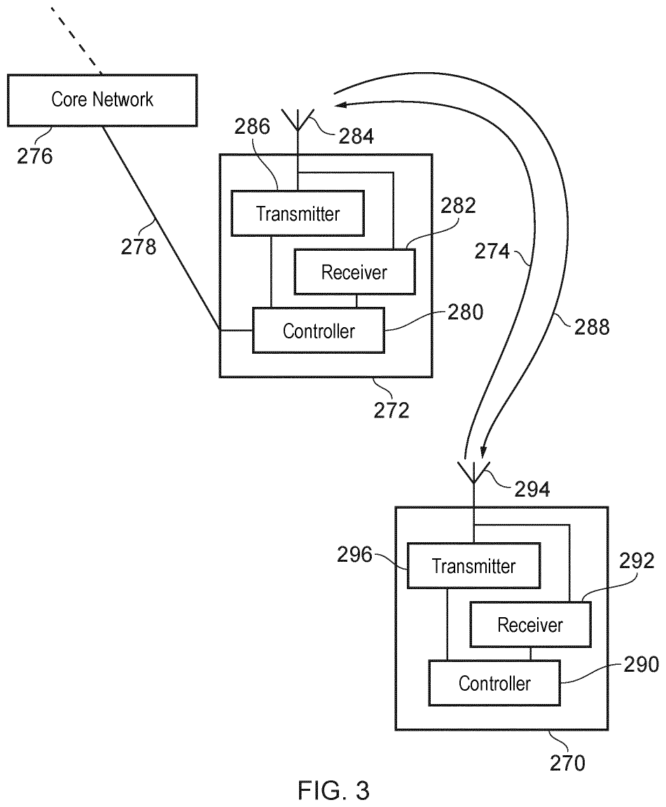

A more detailed illustration of a UE 270 and an example network infrastructure equipment 272, which may be thought of as a gNB 101 or a combination of a controlling node 221 and TRP 211, is presented in FIG. 3. As shown in FIG. 3, the UE 270 is shown to receive downlink data from the infrastructure equipment 272 via resources of a wireless access interface as illustrated generally by an arrow 274. The UE 270 receives the downlink data transmitted by the infrastructure equipment 272 via communications resources of the wireless access interface (not shown). As with FIGS. 1 and 2, the infrastructure equipment 272 is connected to a core network 276 via an interface 278 to a controller 280 of the infrastructure equipment 272. The infrastructure equipment 272 includes a receiver 282 connected to an antenna 284 and a transmitter 286 connected to the antenna 284. Correspondingly, the UE 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the UE 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

### Example Services

As mentioned above, there are a variety of services which may be supported by wireless communications networks. Development of physical layer, radio access and media access protocols and techniques can be adapted to support such services. Example services which are being defined for 5G/New Radio (NR) are the Ultra-Reliable and Low Latency Communications (URLLC) and the enhanced Mobile BroadBand (eMBB) services. URLLC has very low latency and high reliability where a URLLC data packet (e.g. 32 bytes) is required to be transmitted from the radio protocol layer ingress point to the radio protocol layer egress point of the radio interface within 1 ms with a reliability of 99.999% [5] to 99.9999%. On the other hand, eMBB requires high data rate of for example 20 Gbps with moderate latency and reliability (e.g. 99% to 99.9%).

Example developments for 3GPP are eURLLC [6] and NR Unlicensed (NR-U) [8]. For the example of eURLLC proposals have been made to specify features for high reliability and low latency services such as factory automation, transport industry, electrical power distribution, etc. in a 5G system. Unlicensed radio frequency resources refer to a concept in which the radio resources are not exclusively allocated to a particular operator or radio communications system but are shared between systems, which to some extent compete for these resources. An example application for unlicensed spectrum is a 3GPP Release-16 NR-U work item which specifies features which include incorporating Listen Before Talk (LBT) in NR frame structure to enable NR operation in unlicensed bands.

### PDSCH HARQ-ACK Feedbacks

Certain embodiments of the disclosure relate to apparatus and methods for handling acknowledgment signalling (e.g. HARQ-ACK signalling) in respect of transmissions of data in a wireless telecommunications system. Acknowledgment signalling is used in wireless telecommunications systems to indicate whether a transmission was successfully received or not. If the transmission was successfully received the receiving entity will send positive acknowledgment signalling (i.e. an ACK), and if the transmission was not successfully received the intended recipient entity will send negative acknowledgment signalling (i.e. a NACK). The term acknowledgment signalling will be used herein to refer collectively to both positive acknowledgment signalling (i.e. ACK) and negative acknowledgment signalling (i.e. NACK).

For scheduled transmission of data from a network access node (base station) to a communications device in a wireless telecommunications system it is common for the network access node to first send control signalling, e.g. on a downlink control channel (such as a PDCCH-Physical Downlink Control Channel), comprising downlink control information (DCI) which indicates (grants) downlink radio resources that are to be used to transmit the data, e.g. on a downlink shared channel (such as a PDSCH). From this the communications device can determine uplink radio resources to use to send uplink control information (UCI) comprising acknowledgment signalling in respect of the data, e.g. on an uplink control channel (such as a PUCCH), although it may also be on an uplink shared channel (such as a PUSCH). The communications device then seeks to receive the data on the indicated radio resources on the downlink shared channel. If the communications device successfully decodes the data it transmits a UCI on the determined uplink radio resources comprising an ACK indication, and if the communications device does not successfully decode the data it transmits a UCI on the determined uplink radio resources comprising a NACK indication. This allows the network access node to determine if it should schedule a retransmission of the data.

So as to provide some particular examples, certain embodiments of the disclosure will be described herein in the context of acknowledgement signalling for downlink transmissions of URLLC data and using terminology, for example in respect of channel names such as PUCCH and PDSCH and signalling names, such as DCI and UCI, which are typically used in connection with current 3GPP wireless telecommunications systems. However, it will be appreciated this is only for convenience, and in general the approaches discussed herein are applicable for other service types and in wireless telecommunications systems which use different terminology. Thus, references herein to PUCCH should, unless the context demands otherwise, be read as referring to a physical uplink control channel generally, and not specifically to a particular format of physical uplink control channel, and so on for other channels and terminology that may be referred to herein.

HARQ-ACK (Hybrid Automatic Repeat Request acknowledgement signalling) feedback is transmitted by a communications device to a base station in respect of PDSCH scheduling to inform the base station whether the communications device has successfully decoded the corresponding PDSCH or not. Radio resources in wireless telecommunications resources comprise a grid of resources (i.e. a radio frame structure) spanning frequency and time. The frequency dimension is divided into sub-carriers and the time dimension is divided into symbols (e.g. OFDM symbols) that are grouped into slots.

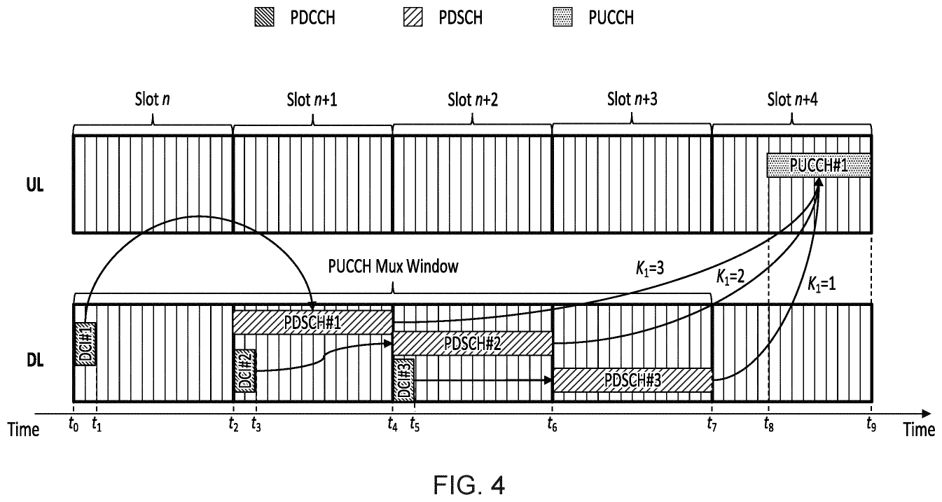

In some current systems, for a PDSCH ending in slot n, the corresponding PUCCH carrying the HARQ-ACK acknowledgement signalling is transmitted in slot n+K₁, where the value of K₁ is indicated in the field “PDSCH-to-HARQ_feedback timing indicator” in the downlink (DL) Grant for the PDSCH (carried by DCI (downlink control information) Format 1_0 or DCI Format 1_1). Multiple (different) PDSCHs can point to the same slot for transmission of their respective HARQ-ACKs, and multiple HARQ-ACKs in the same slot can be multiplexed into a single PUCCH. Hence a PUCCH can contain multiple HARQ-ACKs for multiple PDSCHs. An example of this is represented FIG. 4.

FIG. 4 schematically shows an uplink radio resource grid (top half of figure) and downlink radio resource grid (bottom half of figure) representing radio resources in time (horizontal axis) and frequency (vertical axis). FIG. 4 schematically shows radio resources used by a communications device In an example, scenario during a period spanning five slots (identified in FIG. 4 as slots n to n+4). In slot n the communications device receives downlink control information (DCI #1) indicating an allocation of radio resources on a physical downlink shared channel (PDSCH #1) in slot n+1 with a PDSCH-to-HARQ_feedback timing indicator value of K₁=3. In slot n+1 the communications device receives downlink control information (DCI #2) indicating an allocation of radio resources on a physical downlink shared channel (PDSCH #2) in slot n+2 with a PDSCH-to-HARQ_feedback timing indicator value of K₁=2. In slot n+2 the communications device receives downlink control information (DCI #3) indicating an allocation of radio resources on a physical downlink shared channel (PDSCH #3) in slot n+3 with a PDSCH-to-HARQ_feedback timing indicator value of K₁=1. Thus, in this particular example scenario, the HARQ-ACK feedbacks for each of the three downlink transmissions on the physical downlink shared channel are scheduled to be transmitted by the communications device in slot n+4 and so can be transmitted in a multiplexed manner. To support this multiplexed HARQ-ACK function a Multiplexing Window may be defined, wherein the Multiplexing Window is a time window indicating how many PDSCHs can have their associated HARQ-ACK signalling multiplexed in PUCCH in a single slot and may depend on the range of K₁ values. In the example in FIG. 4, the PUCCH Multiplexing Window is assumed to be from Slot n to Slot n+3, which means the max K₁ value that can be used in this period is 4.

In some systems (e.g. Release-15 system), only one PUCCH per slot is allowed to carry HARQ-ACKs for the same communications device even if the different PUCCHs do not overlap in time. In these systems, the PUCCH resource is indicated in the “PUCCH Resource Indicator” (PRI) field in the downlink Grant. Each downlink Grant may indicate a different PUCCH resource, but the communications device will follow the PRI indicated in the last PDSCH in the PUCCH Multiplexing Window since the communications device only knows the total number of HARQ-ACK bits after the last PDSCH is received.

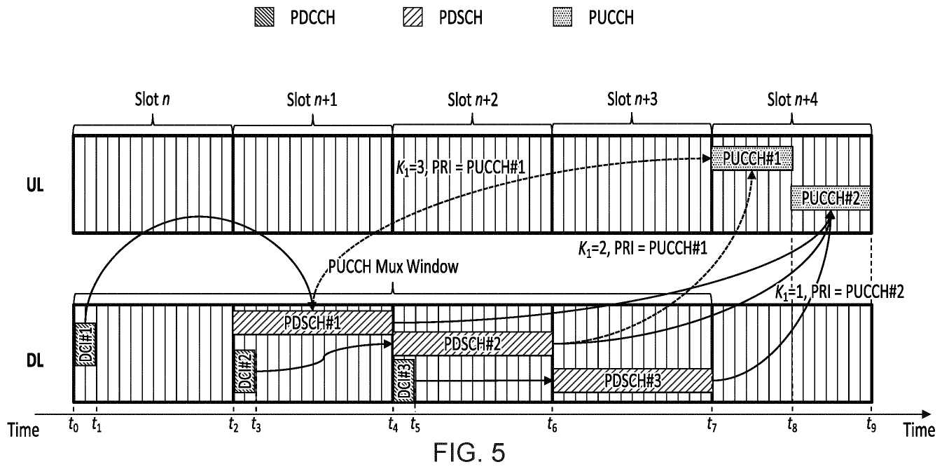

The operation of such a system is illustrated in FIG. 5, where DCI #1 and DCI #2 indicate PUCCH #1 for the HARQ-ACKs corresponding to PDSCH #1 and PDSCH #2, but DCI #3 indicates PUCCH #2 for the HARQ-ACK corresponding to PDSCH #3. Here, PUCCH #1 and PUCCH #2 do not overlap in time. Using the technique mentioned above of having only one uplink control transmission per time unit (e.g. slot) for transmitting acknowledgement feedback and since in this example DCI #3 schedules the last PDSCH (PDSCH #3), in the Multiplexing Window, the communications device will use PUCCH #2 to carry the HARQ-ACK for PDSCH #1,

PDSCH #2 and PDSCH #3. It will be appreciated that in such system other uplink control transmissions, e.g. a PUCCH carrying other UCI such as a SR (Scheduling Request), may be transmitted separately from a PUCCH carrying HARQ-ACK feedback within the same time unit (e.g. slot), in particular if they do not overlap in time.

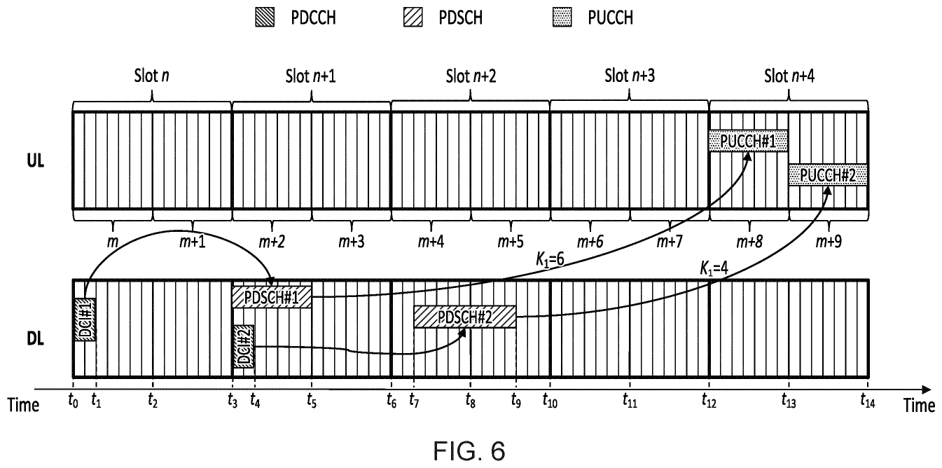

For other systems (e.g. systems in accordance with Release 16 of the 3GPP standards), the possibility of sub-slot operation for HARQ-ACK acknowledgement signalling was introduced. Sub-slot operation for HARQ-ACK allows the timings of HARQ-ACK UCI on PUCCH to be configured with a resolution which is less than one slot (i.e. the HARQ-ACK process operates with sub-slot timing granularity). Sub-slot based PUCCH thus allows more than one PUCCH carrying HARQ-ACKs to be transmitted within a slot. This provides for more opportunities for PUCCH carrying HARQ-ACK in respect of PDSCH transmissions to be transmitted within a slot, thereby potentially helping to reduce the latency of HARQ-ACK feedback. In a sub-slot based PUCCH, the granularity of the K₁ parameter (i.e. the time difference between the end of PDSCH and the start of its corresponding PUCCH) is in units of sub-slot instead of slot, where the sub-slot size can be 2 symbols or 7 symbols. An example of sub-slot HARQ-ACK operation is shown in FIG. 6.

FIG. 6 is similar to, and will be understood from, FIG. 5, but this example schematically shows an uplink radio resource grid (top half of figure) and downlink radio resource grid (bottom half of figure) representing radio resources in time (horizontal axis) and frequency (vertical axis) in a scenario that supports sub-slot operation for HARQ-ACK feedback with a sub-slot size of 7 symbols (i.e. half a slot in this case). FIG. 6 schematically shows radio resources used by a communications device in an example scenario during a period spanning five slots (identified in FIG. 6 as slots n to n+4)/ten sub-slots (identified in FIG. 6 as sub-slots m to m+9). In sub-slot m the communications device receives downlink control information (DCI #1) indicating an allocation of radio resources on a physical downlink shared channel (PDSCH #1) in sub-slot m+2 with a PDSCH-to-HARQ_feedback timing indicator value of K₁=6. This means the communications device determines the resources PUCCH #1 to use for transmitting acknowledgement signalling in respect of PDSCH #1, as indicated by the PRI associated with DC #1, in sub-slot m+8 (since this is the sub-slot which is K₁=6 sub-slots after the sub-slot in which PDSCH #1 ends). In sub-slot m+2 the communications device receives downlink control information (DCI #2) indicating an allocation of radio resources on a physical downlink shared channel (PDSCH #2) that spans sub-slots m+4 and m+5 with a PDSCH-to-HARQ_feedback timing indicator value of K₁=4. This means the communications device determines the resources PUCCH #2 to use for transmitting acknowledgement signalling in respect of PDSCH #2, as indicated by the PRI associated with DCI #2, in sub-slot m+9 (since this is the sub-slot which is K₁=4 sub-slots after the sub-slot in which PDSCH #2 ends). In contrast to approaches according to the systems discussed above (e.g. according to Release 15 of the 3GPP standards specification series), where only one PUCCH carrying HARQ-ACK is allowed in a slot, in a sub-slot based operation, a communications device can transmit two PUCCHs carrying HARQ-ACK (i.e. PUCCH #1 and PUCCH #2) in a slot.

### HARQ-ACK Codebook

HARQ-ACK codebook is used to carry multiple HARQ-ACK feedbacks for PDSCH. In Release-15 there are two types of HARQ-ACK codebooks:
Type 1 HARQ-ACK codebook: Also known as semi-static HARQ-ACK codebook where the number of HARQ-ACK entries is fixed, i.e. semi-statically configured by RRC. Since the HARQ-ACK entries are fixed, there is no confusion between UE and gNB on the number of HARQ-ACK feedbacks the UE should transmit to the gNB if the UE missed a downlink grant (i.e. missed a PDSCH). However, allocated a fixed number of HARQ-ACK feedbacks can waste resources since PDSCH that are not scheduled are still being feedback as NACK.
Type 2 HARQ-ACK codebook: Also known as dynamic HARQ-ACK codebook where the number of HARQ-ACK entries is dynamic and based on the actual number of PDSCH being received. To avoid confusion on the number of HARQ-ACK feedbacks due to the UE missing Downlink grants a “Downlink Assignment Index” (DAI) is used to keep track of the number of PDSCH transmitted to the UE. The DAI is included in the Downlink grant and is incremented when the gNB schedules a PDSCH to the UE using Type 2 HARQ-ACK codebook.

The Downlink Assignment Index (DAI) is typically used for a dynamic HARQ-ACK codebook (e.g. Type 2 and enhanced Type 2 for NR-U) by the UE to keep track of the number of PDSCH scheduled by the gNB to try to ensure that the correct number of HARQ-ACK feedbacks are sent to the gNB. In other words, the DAI serves as a downlink transmission counter and the UE is configured to use the DAI values to provide acknowledgement feedback, for example to determine how many transmissions have to be acknowledged and/or to determine whether to send a positive or negative acknowledgement for the expected downlink transmissions.

The DAI is indicated in the DCI field “Downlink Assignment Index” of the downlink Grant (e.g. defined in DCI Format 1_0, 1_1 or 1_2). There are currently two defined types of DAI's: a Counter DAI (C-DAI) and a Total DAI (T-DAI), where typically the C-DAI comprises or consists of the 2 most significant bits and T-DAI comprises or consists of the 2 least significant bits of the DAI field.

In the interest of simplicity and ease of illustration, the present disclosure will focus on a two-bit DAI such as a C-DAI.

Presently, the C-DAI is configured for dynamic HARQ-ACK codebook and consists of 2 bits, which is incremented whenever a downlink data transmission (e.g. PDSCH) is scheduled for the UE. When the number of PDSCH exceeds 4, the counter wraps around to 00. The UE keeps track of the number of times C-DAI wraps around and by doing so can determine the number of PDSCH being scheduled. As long as the UE (1) does not miss 4 or more consecutive DL Grants or (2) does not miss the last downlink Grant (e.g. if it misses the downlink control transmission that schedules the downlink data transmission) prior to the corresponding uplink transmission (e.g. PUCCH) for acknowledging the downlink transmissions, the UE is able to keep track of the number of scheduled PDSCH.

For the sake of completeness, the T-DAI may be configured for dynamic HARQ-ACK codebook typically when multiple carriers are used and includes of 2 bits. This gives the total number of PDSCH the gNB schedules the UE across all serving cells (in a multiple carriers operation) within a PDSCH Occasion. As mentioned above, the techniques disclosed herein in respect of a C-DAI/two bit DAI apply equally when a T-DAI is used.

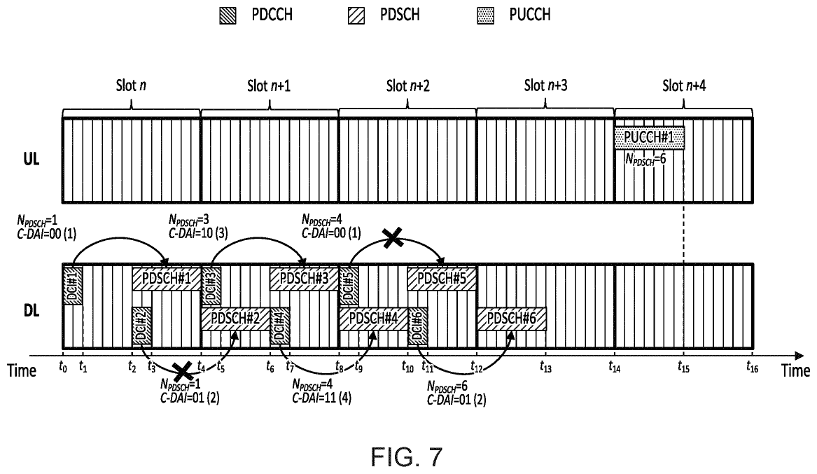

FIG. 7 illustrates an example use of a DAI (e.g. C-DAI) to assist the UE in identifying which downlink transmissions it might have missed. In this example, for ease of illustration, a C-DAI in a single serving cell is illustrated (e.g. the T-DAI not configured or not represented in this example). Here the C-DAI consists of two bits indicated in the downlink Grant. The DAI conventionally start with 00 (although it may equally start from any other pre-agreed value) such that “00”=1. It is then incremented so that “01”=2, “10”=3 and “11”=4. The UE can implement an internal counter of downlink transmissions scheduled by the base station, such as N_{PDSCH}. The counter can be seen as a UE's internal counter of the number of PDSCH received for a dynamic HARQ-ACK codebook (e.g. Type 2 or enhanced Type 2). It will be appreciated that in an arrangement where the UE knows how many HARQ-ACKs have been pre-configured, such as in a Type-1 codebook system (where the terminal will transmit a preconfigured number of acknowledgement feedbacks according to the codebook), the use of a counter may not be as valuable compared to a more dynamic system. Such counters are thus expected to be used mostly in systems where the HARQ-ACKs in a Codebook for allocation of downlink transmissions, such as data transmissions, are at least partially dynamic.

In FIG. 7, downlink Grants DCI #1, DCI #2, DCI #3, DCI #4, DCI #5 and DCI #6 schedule PDSCH #1, PDSCH #2, PDSCH #3, PDSCH #4, PDSCH #5 and PDSCH #6 respectively, where all their HARQ-ACK feedbacks are to be multiplexed into PUCCH #1 in Slot n+4. The UE receives the first DL Grant, DCI #1 successfully where it indicates C-DAI=1 and so the UE updates its internal counter N_{PDSCH}=1. The UE missed DCI #2 and so at time t₃ it still assumes N_{PDSCH}=1. At time t₄, it receives DCI #3 where it expects C-DAI=2 but instead C-DAI=3 is indicated. On that basis, the UE can identify or determine that it has missed a downlink (data) transmission in the form of PDSCH #2 and update its counter N_{PDSCH}=3. The UE receives DCI #4, where C-DAI matches its internal counter and updates N_{PDSCH}=4. The UE misses DCI #5 but receives DCI #6. Using the same procedure as above, the UE is able to determine that it has missed PDSCH #5. The UE can then correct its internal counter to N_{PDSCH}=6 and can feedback six HARQ-ACKs where it indicates NACK for the downlink transmissions (PDSCH #2 & PDSCH #5) that it has missed.

### Uplink L1 Priority Indicator

Certain embodiments as described in the present disclosure may concern an arrangement where different priorities may be used for uplink transmissions. For example, a priority indicator may be provided when uplink resources are allocated to a UE for uplink transmissions.

Such a priority indicator for uplink transmissions has been proposed for 3GPP standards, in which a different priority is allocated for uplink transmissions where these uplink transmissions collide and so one must be chosen over the other. In some systems, such as previous versions of 3GPP standards (e.g. Release 15), there was no provision for a different priority level at the Physical Layer and when two uplink transmissions collide, information for uplink transmissions is multiplexed and transmitted using a single channel. Possible collisions of uplink resources can include a PUCCH with PUCCH and PUCCH with PUSCH. In this respect the collision occurs and can be identified at the physical layer. For example, Release 15 systems and other systems were configured to provide different priority levels for the media access control layer, which included sixteen priority levels, but not the physical layer.

As explained above, a UE can be configured to provide eMBB and URLLC services contemporaneously. Since eMBB and URLLC have different latency requirements, their uplink transmissions may collide. For example, after an eMBB uplink transmission has been scheduled, an urgent URLLC packet arrives which would need to be scheduled immediately and its transmission may collide with the eMBB transmission. In order to handle such intra-UE collisions with different latency and reliability requirements, two priority levels at the physical layer have been proposed in Release-16 for Uplink transmissions, such as for example transmissions via PUCCH and PUSCH channels. In Release-16 intra-UE prioritisation is used, that is, when two UL transmissions with different Physical Layer priority levels (L1 priority) collide, the UE will drop or cancel the lower priority transmission. If both UL transmissions have the same L1 priority then the UE is configured to multiplex the transmissions according to that proposed in Release-15 procedures. The gNB indicates the L1 priority to the UE in the 1 bit “Priority indicator” DCI field, where “0” indicates Low L1 priority and “1” indicates High L1 priority and:
For PUSCH, the L1 priority is indicated in the uplink grant carried by DCI Format 0_1 and 0_2.
For PUCCH carrying HARQ-ACK feedback for PDSCH, the L1 priority is indicated in the Downlink grant scheduling a PDSCH, carried by DCI Format 1_1 and 1_2

According to these examples therefore, the downlink control information (DCI) carries a priority level indicator associated with the uplink transmission (e.g. for carrying acknowledgement information) associated with the downlink transmission for which resources are being granted by the downlink control information, and the indicator may be associated with different DCI formats depending on whether the downlink control information scheduling a PUSCH or a PUCCH.

More generally the uplink transmissions for sending acknowledgement information may be associated with different priorities, with a least a high priority and a low priority and the priority is usually indicated in the downlink control information sent for scheduling the downlink (e.g. data) transmissions to be acknowledged.

Since the PUCCH can have two L1 priorities, two HARQ-ACK codebooks of different priorities can be configured for a UE. This allows High L1 priority HARQ-ACKs to be multiplexed into a High L1 priority HARQ-ACK codebook and Low L1 priority HARQ-ACKs to be multiplexed into a Low L1 priority HARQ-ACK codebook.

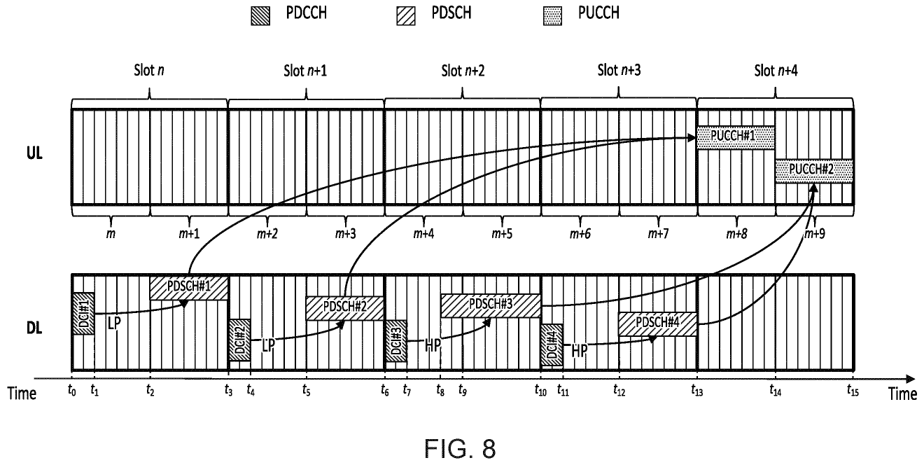

An example is shown in FIG. 8 which illustrates an arrangement in which two HARQ-ACK codebooks are provided with two different priorities. In the example shown in FIG. 8, the gNB transmits to the UE in a PDCCH (downlink control channel) a sequence of four downlink control information transmissions DCI #1, DCI #2, DCI #3, DCI #4, which respectively indicate an allocation of downlink resources PDSCH #1, PDSCH #2, PDSCH #3, PDSCH #4 respectively. As indicated in FIG. 8, two of the downlink control information transmissions DCI #1, DCI #2 schedule a Low L1 priority PUCCH #1 in sub-slot m+8 which carries a Low L1 priority HARQ-ACK codebook to multiplex the HARQ-ACK feedbacks for PDSCH #1 and PDSCH #2 as represented by the arrows. In contrast the second two downlink control information transmissions DCI #3, DCI #4 schedule a High L1 priority PUCCH #2 in sub-slot m+9 which carries a High L1 priority HARQ-ACK codebook to multiplex the HARQ-ACK feedbacks for PDSCH #3 and PDSCH #4. Hence, according to this example, the gNB can use different PUCCH that can have different reliability to carry HARQ-ACK with different L1 priorities.

### PUCCH Resource Determination

The uplink control information (e.g. “UCI”) for sending acknowledgement information is typically carried by the Physical Uplink Control Channel (PUCCH), where the PUCCH time and frequency resource used is determined using the number of UCI information bits N_{UCI}. In other words, which resources to use will be dependent on the number of acknowledgement feedbacks to send.

As an illustration, in current system, there are 4 PUCCH Resource Sets, where each PUCCH Resource Set has a maximum limit on the number of UCI information bits that it can carry and can be configured with certain PUCCH Formats as shown in Table 1 below.

In this arrangement, the values N₂ and N₃ are RRC configurable via the parameter maxPayloadMinus1 which can have a value 4 to 256 bits, where N₃>N₂. There are 5 PUCCH formats {0, 1, 2, 3, 4} and the PUCCH resource in PUCCH Resource Set ID 0 can only use PUCCH Format 0 and 1 whilst the other sets can only use PUCCH Format 2, 3 & 4.

TABLE 1
PUCCH Resource Set

| Set | Number of PUCCH | | |
|---|---|---|---|
| ID | Resources | Maximum UCI Bits | PUCCH Format |
| 0 | 8 to 32 (configurable) | 3 (2 bits + SR) | Format 0 & 1 |
| 1 | 8 | N₂ (configurable) | Format 2, 3 & 4 |
| 2 | 8 | N₃ (configurable) | Format 2, 3 & 4 |
| 3 | 8 | 1706 | Format 2, 3 & 4 |

UE firstly selects a PUCCH Resource Set based on the number of UCI information bits N_{UCI} that needs to be carried by the PUCCH as follows:
If N_{UCI}≤2 bits and the UCI is HARQ-ACK and/or SR then the UE selects PUCCH Resource Set ID 0. In this arrangement, PUCCH Format 0 can carry two HARQ-ACK feedbacks and 1 scheduling Request “SR”, i.e. 3 bits (at least).
If 2 bits<N_{UCI}≤N₂, then the UE selects PUCCH Resource Set ID 1.
If N₂<N_{UCI}≤N₃, then the UE selects PUCCH Resource Set ID 2.
If N₃<N_{UCI}≤1706 bits, then the UE selects PUCCH Resource Set ID 3

Once the PUCCH Resource Set is selected, the UE selects a PUCCH Resource in that set. There are at least 8 PUCCH Resources in each PUCCH Resource Set and for HARQ-ACK feedbacks, the PUCCH Resource to select is indicated in the downlink grant, e.g. in a PRI field of the DL Grant (see discussion above regarding FIG. 5 for example).

The selected PUCCH Resource determines the time resource, e.g. starting symbol in a slot and the duration of the PUCCH. The frequency resource, i.e. number of PRBs up to a pre-configured maximum PRB, used to carry the PUCCH is determined after encoding the UCI bits using a pre-configured code rate.

In other words, the number of acknowledgement feedbacks to report will have an impact on the selection of the resources for reporting these feedbacks, such as the selection of the timing of these resources. The same challenges also occur in a situation where the number of acknowledgement feedbacks can additionally or alternatively impact the selection of the frequency resources to select for transmitting these feedbacks.

It will be appreciated that this is an example of a selecting resources for sending acknowledgement information based on example existing or possible systems but that the teachings of the present disclosures apply also to other systems.

In particular, it is expected that in many systems, if the UE does not know how many acknowledgement feedbacks to send or has identified an incorrect number of acknowledgement feedbacks to send, the UE might identify or select uplink resources (for sending the acknowledgements) which do not correspond to the resources that the base station expects the terminal to identify or select.

Said differently, if both the UE and base station identify resources for sending or receiving, respectively, acknowledgement information based on a number of acknowledgement feedbacks to be reported (e.g. based on a number of downlink transmissions to be acknowledged), then discrepancies in the determination of this number by the terminal and by the base station can result in a failure to communicate all acknowledgement information successfully.

Accordingly, assisting the UE in selecting the resources that the base station expects the UE to select would reduce the likelihood of having to retransmit more downlink transmission, especially downlink transmissions that have actually been successfully received but where this could not be reported to the network in a manner which enabled the network to recognise which downlink transmissions had been successfully received.

Additionally and as described above, in some systems (e.g. in Release 16 systems), prioritization is used to handle intra-UE uplink collisions where the Low L1 Priority (LP) uplink transmissions (e.g. PUCCH) is dropped when it collides with a High L1 Priority (HP) uplink transmissions (e.g. PUCCH). An uplink transmission (e.g. PUCCH) typically carries HARQ-ACKs for multiple PDSCHs and hence when an uplink transmissions (e.g. PUCCH) is dropped due to prioritization, the corresponding downlink transmissions (e.g. downlink data transmissions such as PDSCHs) may be retransmitted which would consume a lot of downlink resources and also unduly increase transmissions delays.

Recognising this difficulty, in other systems (e.g. in Release 17 systems), multiplexing of uplink control transmissions (e.g. UCIs) with different L1 priorities is introduced. This is done with a view to avoiding the dropping of LP HARQ-ACKs and the associated limitations mentioned above.

In such a system, the downlink Grants scheduling LP PUCCH are expected to be configured to be less reliable than downlink Grants scheduling HP PUCCH, as LP transmissions tend to be associated with a higher error rate, e.g. BLER, than the error rate of the HP transmissions. Accordingly, the UE is more likely to misjudge and thus misreport the number of LP HARQ-ACKs (N_{LP}) compared to the number HP HARQ-ACKS (N_{HP}).

It is expected that a UE misdetecting downlink Grants, especially for those scheduling LP PUCCH, would lead to the wrong number of total UCI bits N_{UCI}, where N_{UCI}=N_{LP}+N_{HP}, for UCI multiplexing (e.g. in a Type 2 codebook system). Since the PUCCH resource is determined by the total number of UCI bits, the UE might use a different PUCCH resource compared to what the gNB expects. That is, the misalignment in the number of LP HARQ-ACK N_{LP}, due to a misdetection of downlink Grants by the UE (compared to the number of downlink Grants transmitted by the gNB) can cause the UE to transmit in the wrong uplink resources (e.g. using the wrong PUCCH resources). As a result, the uplink control transmission may not be decoded by the gNB thereby causing HP HARQ-ACK or HP UCIs to be dropped or considered as not received (or as negative acknowledgements by default). This would impact the reliability requirement for URLLC. Such aspects are discussed for example in references [11], [12], [13], [14], [15].

Effectively, the higher risk of errors of misreporting associated with lower priority transmissions is effectively contaminating the high priority feedbacks (which, in isolation, are associated with a lower misreporting error risk level) through the multiplexing of the high and low priority feedbacks.

Different approaches have been considered in view of this limitation.

In one example, the gNB can perform blind decoding for different PUCCHs (that the UE might have selected by mistake) if it fails to decode the expected PUCCH carrying the multiplexed HP & LP HARQ-ACK feedback—in case this was caused by a discrepancy in the number of acknowledgements to send (e.g. caused itself by a discrepancy with number N_{LP}) between UE & gNB. However, such an approach can increase the gNB's complexity and may even lead to detection errors (see reference [12]).

In another example (see reference [11]), it is proposed that a separate group of PUCCH resources is used to carry multiplexed LP & HP HARQ-ACKs instead of using the PUCCH resource for the HP HARQ-ACK to carry the multiplexed UCI bits. It was alleged that this method reduces gNB's blind decoding attempts to two PUCCH candidates. However, this reduction is only provided in cases where the UE misses all of the downlink Grants scheduling the LP PUCCH as in such cases the UE would not even be aware that there is a LP PUCCH colliding with a HP PUCCH. On the other hand, if the UE misses only part of the downlink Grants for the LP uplink transmissions, the same issue would still be relevant. However, in current systems, for a Type 2 CB carrying HARQ-ACKs associated with 2 or more downlink Grants, such a situation would be unlikely since the PDCCH carrying downlink Grants (DCI) for LP PUCCH would typically have a target BLER of 10⁻². Accordingly, having a UE missing 3 or more downlink Grants has a probability of about 10⁻⁶, which is equivalent to reliability of URLLC and thus an unlikely occurrence. This approach is thus expected to only provide insignificant improvements in relation to this situation.

In other examples (see for example references and [13]), it is proposed that when multiplexing LP and HP HARQ-ACKs, the possible number of LP HARQ-ACK N_{LP}, is fixed to a set of reference values. In reference [12], these reference values can be semi-statically configured. In reference [13], the N_{LP} is quantised, and that the UE rounds up to the nearest quantized value. For example, the reference values can be N_{LP-REF}={5, 10, 15, 20} and if the gNB PDSCHs scheduling results in N_{LP}=3 LP and N_{HP}=2, the UE would assume N_{LP}=5, i.e. using the nearest reference value of N_{LP-REF}. Hence using this method, the total number of UCI bits N_{UCI}=5 (N_{LP}=N_{LP-REF}=5)+2 (N_{HP})=7 multiplexed UCI bits in determining the PUCCH resource. While this method reduces the number of cases where a UE/gNB misalignment of number of feedbacks to be sent might cause an unsuccessful transmission of feedback, this approach does not address the root cause of the limitation. Instead this approach tries to address the consequences of misalignment, and does so by unnecessarily creating overhead for the uplink control signalling (e.g. PUCCH) which defeats the purpose of using dynamic allocations systems (such as a Type 2 codebook) in the first place.

In further examples (e.g. in references [14] and [15]), it is proposed to indicate information on Np in the downlink Grant corresponding to HP HARQ-ACK or HP uplink control PUCCH. For example, the Downlink Assignment Index (DAI) for LP HARQ-ACKs (e.g. the DAI for a PDSCH to be acknowledged in a LP acknowledgement) in the DCI carrying the downlink Grant associated with HP HARQ-ACKs. While this can help the terminal identify the N_{LP} number with a relatively high reliability (as the downlink DCI will be configured with a low BLER), a number of additional DCI bits would have to be used for the downlink Grant associated to HP HARQ-ACK, which would not only increase the overhead but may also impact its reliability (thereby being counter-productive for high-reliability transmissions).

Accordingly, in a system where high and low priority acknowledgement feedbacks are multiplexed, a misreporting of feedbacks can have consequences which may be even more damaging as high priority downlink transmissions would be assumed not received even if they have been received-which would create delays (even though HP transmissions are often for low latency communications) and reduce the efficiency of the network by retransmitting already received transmissions. Approached proposed to try to overcome this limitation or to reduce its impacts are of limited efficacy and/or increase overhead and/or reduce reliability for the high priority uplink transmissions.

Therefore, in such a HP/LP acknowledgement multiplexing system, a misalignment of the number of LP HARQ-ACKs N_{LP} (which is more likely than a misalignment of N_{HP}) between the base station and the UE due to misdetection of downlink Grants is undesirable. On the other hand, it can be difficult to detect this number accurately without a significant impact on the uplink control signalling (e.g. PUCCH) overhead or downlink control signalling (e.g. DCI) overhead.

It will however be appreciated that the challenges discussed herein are applicable to situations both with and without multiplexing of different priority feedbacks:
as mentioned above, this might happen with any transmissions, e.g. due to the nature of the counter or other type of transmission identification system (e.g. DAI). If the identification systems have some limitations and is not entirely fool-proof, there is then an associated risk of misreporting feedback and transmitting the feedback reporting information differently from expected by the base station, wherein the base station may then not be able to determine any feedback information for any of the downlink transmissions to be reported.
While it has generally been considered acceptable in current system that some of the LP transmissions would have to be retransmitted because of such limitations, improving the reporting mechanisms would still improve the reliability and efficiency of the network.
Likewise, while the risk of these limitations affecting the higher priority transmissions is considered low enough to be acceptable (e.g. unless negatively affected by lower priority reporting), better managing this error risk would further improve the reliability and efficiency of the network for high priority transmissions.

### Ending Grants Indicator

In accordance with techniques discussed herein, the base station can signal an Ending Grants Indicator (EGI) in the last K_{LP} downlink Grants, associated with an uplink acknowledgement transmission (e.g. a PUCCH).

The terminal can use the EGI to determine how many transmissions (to be acknowledged) were expected and thus determine more accurately how many acknowledgement feedbacks are to be sent. From one perspective, the EGI can assist the UE in determining whether it has missed up to K_{LP} consecutive downlink Grants prior to the associated PUCCH that carries the HARQ-ACKs.

As observed in reference [16], a counter mechanism using 2 bits (e.g. DAI or C-DAI) used to mitigate against misdetection of downlink Grants would fail if:
The UE misses at least 4 consecutive downlink Grants thereby causing the C-DAI (2 bits) to wrap around as the UE would be unable to detect any discrepancy, or.
The UE misses the last downlink Grant(s) since there will not be further DAI updates after the last downlink Grant, the UE would not be able to determine whether it has missed any downlink Grants.

While not impossible, it is very unlikely for the UE to miss 4 consecutive downlink Grants such that a DAI failure caused by a DAI wrap around. As an illustration, if a Low Priority service such as eMBB has a BLER target of 10⁻² for its PDCCH carrying the downlink Grant, then the probability of the UE missing 4 consecutive downlink Grants would be of the order of 10⁻⁸. This is significantly below the 10⁻⁶ or 10⁻⁵ reliability target used for URLLC services (at least a 100 times less likely to happen compared to a midsection of a URLLC downlink Grant) which is considered sufficient for a high reliability service.

However, it is more likely that misdetection would result from the UE missing the last downlink Grant associated to a LP PUCCH since the probably of misdetection for a DCI carrying a downlink Grant for a LP PUCCH is 10⁻². The probability of a misdetection of the last 2 downlink Grants associated to a LP PUCCH is about 10⁻⁴, which still higher than the URLLC reliability requirements. It will thus be appreciated that the more likely cause of failure of a counter mechanism (e.g. the DAI mechanism used in Type 2 CB) is linked to a misdetection of the last few consecutive downlink Grants associated with an uplink transmission (e.g. PUCCH).

Accordingly, K_{LP} may be configured to be based to what is deemed likely or unlikely regarding the number of last downlink grants that the UE may miss. For example, if it is deemed highly unlikely that the UE would miss the last three Grants associated with an uplink acknowledgement (e.g. with a PUCCH for reporting the feedback), K_{LP} may be configured to be equal to at least three. This is because the UE would be expected to receive at least one of the last three grants in the vast majority of cases.

In some examples, the value of K_{LP} to be used can be configured via one or more of: RRC signalling, system information, or predefined (e.g. fixed in an agreed standard). It may also be a combination of these examples. For example, the standard may define two or more configurations each associated with a K_{LP} value and which of the pre-defined configuration to use may be identified in RRC signalling.

Alternatively or additionally, and in an example where the downlink transmissions to be acknowledged are associated with a wrap-around counter (e.g. DAI or C-DAI), the value of K_{LP} can be configured to be less than the maximum counter value (e.g. C-DAI value). For example, if the counter is a 2 bit counter (with a maximum of counter value of 4 before it wraps around) then K_{LP} may be set to 3, or even 2. This recognizes that a wrap-around counter (e.g. DAI) will often be designed with an expectation that a failure due to the counter wrapping around is highly unlikely or considered as an acceptable error risk. Accordingly, if a wrap-around counter has a maximum value of Nₘₐₓ, the UE will be expected to almost always be able to receive the last Nₘₐₓ downlink Grant and a value lower than Nₘₐₓ may be deemed more appropriate for identifying the last downlink Grant transmitted by the base station and associated with an uplink transmission (e.g. PUCCH).

It will however be appreciated that K_{LP} can still be greater than or equal to Nₘₐₓ and that the teachings and techniques provided herein would still be applicable.

It will also be appreciated that, as discussed above, the teachings and techniques discussed herein such as the use of an EGI for the K_{LP} last downlink transmissions (e.g. downlink data transmissions such as PDSCH) to be sent to a terminal can be used in a system with or without the multiplexing of acknowledgement feedbacks.

### Ending Grants Indicator Signalling

As will be clear from the discussion below, there are different ways that the EGI could be signalled to the UE and any of these techniques may be combined as appropriate, for example to take advantage of the different benefits associated with each example technique.

In an example, the EGI is a 1 bit indicator. It may for example be included in the downlink control information (e.g. the Downlink Control Information and/or downlink Grant) that schedules a downlink transmission that is associated with an uplink acknowledgement feedback. As a one bit EGI can take two values, one value can viewed as being a positive value (to indicate one of the last Grants or downlink transmissions) and the other as being a negative value (to indicate that this is not yet one of the last Grants or downlink transmissions). It will be appreciated that “1” can either be used to indicate positive or negative and “0” to indicate negative or positive, respectively, as a matter of convention. In the following example, “1” is used to indicate positive but the same teachings can be used with “1” used to indicate negative.

In this one bit example, the EGI is positive, e.g. EGI=“1” when the downlink Grant is amongst the last K_{LP} downlink Grants having an associated uplink transmission (e.g. PUCCH), otherwise the EGI is negative, e.g. EGI=“0”.

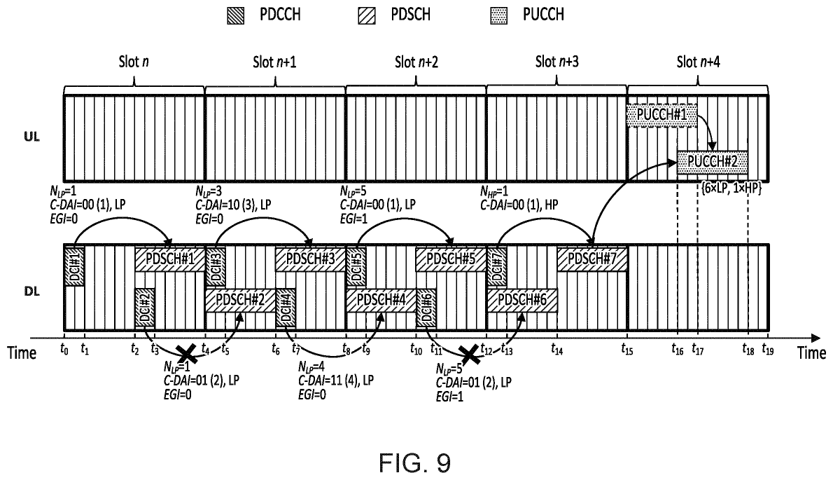

An example of operation is shown in FIG. 9, with a one bit EGI and K_{LP} being configured to 2. In this example, DCI #1, DCI #2, DCI #3, DCI #4, DCI #5 and DCI #6 schedule PDSCH #1, PDSCH #2, PDSCH #3, PDSCH #4, PDSCH #5 and PDSCH #6 respectively where their HARQ-ACKs are originally scheduled to be transmitted in a Low Priority (LP) PUCCH #1 in Slot n+4. UCI multiplexing of different L1 priorities is enabled in this example but it will be appreciated that this technique could still be in this example and without multiplexing (e.g. with only the transmissions associated with a LP PUCCH in the example of FIG. 9).

DCI #1 is the first downlink Grant associated with LP PUCCH #1 and so the C-DAI=00 and the UE internal counter for number of PDSCH or number of LP HARQ-ACKs is set to N_{LP}=1 after decoding DCI #1. It should be noted that in some implementations the UE may internally keep track of the total number of PDSCH, e.g. N_{PDSCH} and/or of the number of Low Priority HARQ-ACKS N_{LP} and High Priority HARQ-ACKS N_{HP}, separately. This example is illustrated by considering N_{LP} and N_{HP} separately as it facilitates the illustration of the techniques associated with the EGI but the same example implementation may rely on keeping track of or counting a total number of packets.

The UE misses DCI #2 and so at time t₃, it wrongly assumes that N_{LP}=1 since it is unaware that PDSCH #2 has been scheduled. After receiving DCI #3, the UE corrects its internal counter N_{LP} to 3 based on the C-DAI. The UE successfully decoded DCI #5 but fails to decode DCI #6 which is the last downlink Grant associated to LP PUCCH #1 and so at time t₁₁, the UE wrongly assumes that N_{LP}=5. DCI #7 schedules PDSCH #7 with a corresponding HP PUCCH #2 and since PUCCH #2 overlaps with PUCCH #1, their HARQ-ACKs are therefore multiplexed and carried by PUCCH #2. In this example K_{LP}=2, that is the gNB would indicate EGI in the last two downlink Grants associate to the LP PUCCH #1. The UE therefore expects two positive EGI indicators, i.e. EGI=“1” but it only receives one positive EGI from DCI #5. It can be observed that without the EGI indicators, the UE would wrongly assume that 5 PDSCHs have been scheduled that are associated with a low priority PUCCH and would thus wrongly multiplex N_{LP}+N_{HP}=5+1=6 HARQ-ACK bits into PUCCH #2. In this example, since the UE knows that there is one missing EGI (as it was expecting two EGIs and received one only, such that it can identify that it has missed the last PDSCH), it knows that there should be 6 LP HARQ-ACKs and therefore multiplexes the correct number of LP HARQ-ACKs, i.e. a total UCI N_{UCI}=7 bits into PUCCH #2.

In some cases, the EGI can be indicated in the downlink Grant scheduling an uplink low priority uplink control transmission (e.g. PUCCH). For example, in the example in FIG. 9, EGI is signalled in the downlink Grants scheduling the LP PUCCH. Sending the EGI in transmissions (e.g. downlink control information) in respect of the LP uplink transmissions avoid increasing the DCI load of the downlink Grant associated with the HP PUCCH, which may impact the URLLC reliability requirements as discussed above.

It will however be appreciated that in some cases, the EGI may be indicated in the downlink Grant scheduling an uplink high (and/or low) priority uplink control transmission (e.g. PUCCH). For example, in some cases the base station will provide the EGI in all downlink Grant, whether they schedule an uplink transmission of low or high priority, or even without a priority assignment.

In some implementations, the EGI can be indicated in a dynamic Multiplexing Indicator in the downlink Grant, or in any other Grant field which is not relevant to the downlink control information transmission (e.g. DCI) carrying the indicator.

In some cases, whether the terminal will have the UCI multiplexing of different L1 priorities enabled and disabled can be indicated by the gNB, for example using a dynamic Multiplexing Indicator. This is discussed for example in and in some implementations, this may be indicated dynamically in the downlink Grant (see for example and [16]). It is expected that this Multiplexing Indicator would only be used in downlink Grant scheduling a HP PUCCH, in order to indicate to the UE whether to multiplex the feedbacks with the low priority feedbacks. However, the downlink control signalling is typically defined by a particular format which is not depend on the priority of any uplink transmission that may be scheduled by this signalling. In other words, if a DCI for a downlink Grant (e.g. DCI Format 1_1 and 1_2) comprises a Multiplexing Indicator field, DCI for both LP PUCCH and HP PUCCH would include this field (and for example a “Priority indicator” DCI field indicating the uplink L1 priority). In a case where such a field is used in the downlink Grant, and would be used for its original purpose for HP PUCCH Grants but not for LP PUCCH Grants, such an indicator (e.g. Multiplexing Indicator) may be used to indicate the EGI without creating any additional overhead to the downlink Grant.

While this would have the limitation that the field would not be available to indicate an EGI for a grant associated with a HP uplink transmission (e.g. PUCCH), as discussed above, providing the EGI in Grants for LP PUCCH only is likely to be acceptable such that, in turn, this limitation is likely to be found acceptable as well.

In an example where a field is provided for configuring HP uplink transmission, e.g. PUCCH, Grants (e.g. a DL Grant for a downlink transmission associated with a HP uplink transmission), the field can be used as an EGI when configuring a LP uplink transmission (if for example this purpose of the field—or configuration it relates to—is not relevant to LP uplink transmissions). For example if the Priority Indicator=“0” (which indicates a Low Priority) in the downlink Grant, then the field (e.g. Multiplexing Indicator) can be used as an EGI.

In one example, a dynamic Multiplexing Indicator is used as an EGI if the Priority Indicator=“0” (Low Priority) in the downlink Grant and used as a Multiplexing indicator if the Priority Indicator=“1” (High Priority). In this case, the gNB would configure the Multiplexing Indicator to indicate for example Enable or “1” in the last K_{LP} downlink Grants scheduling the LP PUCCH(s). That is, for an implementation where the Multiplexing Indicator uses 1 bit:
If the downlink Grant Priority Indicator indicates “1” (a High Priority), the Multiplexing Indicator indicates whether UCI multiplexing of different L1 priorities is Enabled (e.g. “1”) or Disabled (e.g. “0”)
If the downlink Grant Priority Indicator indicates “0” (a Low Priority), then the Multiplexing Indicator acts as the EGI.

As mentioned above, the techniques discussed herein may be used in cases with or without multiplexing of feedbacks of different priorities. Accordingly, such a Multiplexing Indicator may be used as an EGI for LP PUCCH whether it is configured to enable the multiplexing or not. As mentioned above, by using a field which is already configured in the grant signalling but which is not relevant to, or not used to configure, the downlink control information transmission (e.g. DCI) carrying the indicator, any overhead associated with this EGI can be better controlled.

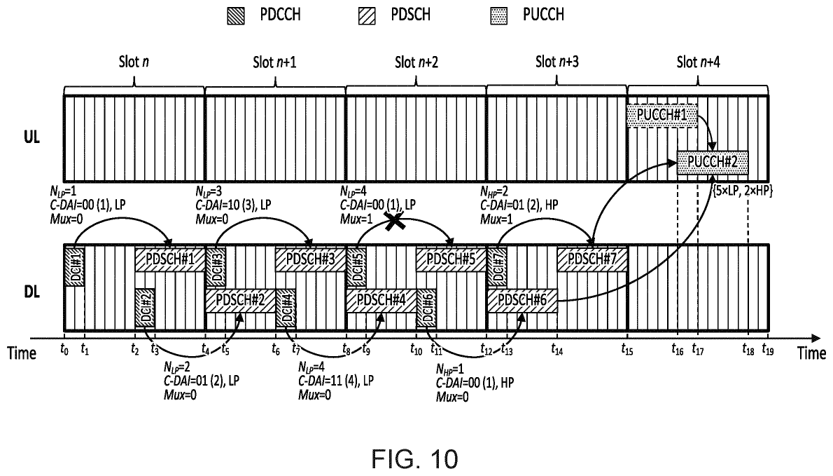

An illustration of this implemented is shown in FIG. 10, where K_{LP}=1 (so only the last LP PDSCH has an associated EGI) and the Multiplexing Indicator is a 1 bit indicator. DCI #1, DCI #2, DCI #3, DCI #4 and DCI #5 schedule PDSCH #1, PDSCH #2, PDSCH #3, PDSCH #4 and PDSCH #5, respectively, with the associated HARQ-ACK feedbacks scheduled to be transmitted in LP PUCCH #1 in Slot n+4.

The UE misses DCI #5 and hence wrongly assumes that N_{LP}=4 HARQ-ACKs. DCI #6 and DCI #7 schedules PDSCH #6 and PDSCH #7 where their HARQ-ACKs are carried by HP PUCCH #2. Here, the gNB sets the Muxltiplexing Indicator to “Enable” in DCI #7, as shown by Mux=1 in FIG. 10. Accordingly, the UE is configured to multiplex the LP HARQ-ACK feedbacks and HP HARQ-ACK feedbacks into PUCCH #2. The UE expects to see one positive EGI (i.e. one Mux=1 in this example) in the last downlink Grant associated with PUCCH #1 but fails to see any. Accordingly it can determine that it has missed at least the last downlink Grant. The UE may miss the last two or more downlink Grants associated with the PUCCH #1 but in this example, we assume that is rare (which can for example justify why K_{LP} is set to 1 in this example) such that the UE will correct N_{LP} to 5 HARQ-ACKs rather than N_{LP}=4 as originally detected. In other words, the UE assumes that it has missed only one DCI (DCI #5). The UE can then send its feedback based on N_{UCI}=5 LP HARQ-ACK+2 HP HARQ-ACK and thus sends 7 bits of acknowledgement feedback in PUCCH #2.

While the example discussion above was mostly based on the re-used field being a 1 bit field, it will be appreciated that the same technique may be used with a longer field, for example with a n-bit field with n>1. It may also be appreciated that if the field that is re-used for indicating the EGI is more than one bit, there could be different options for indicating the EGI, such as a positive/negative indication as discussed above, a counter indication, as discussed below, or any other suitable type of indication.

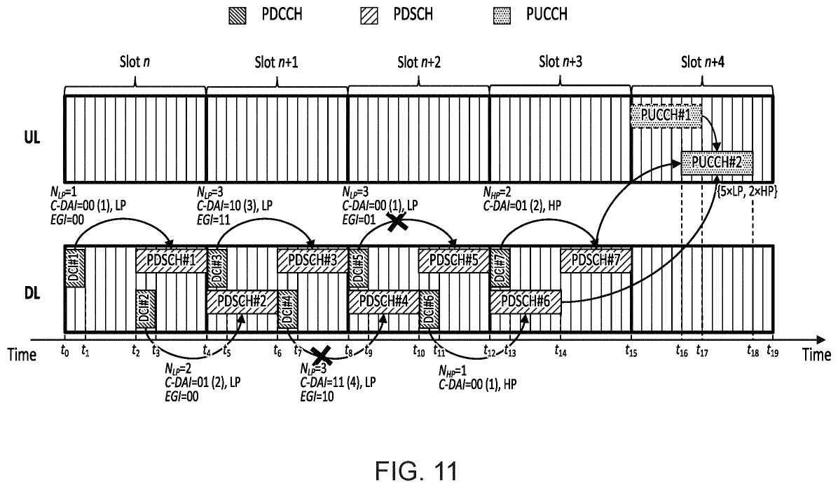

Alternatively or additionally to any of the examples discussed herein, the EGI may be provided as a counter of the last K_{LP} downlink Grants associated with the PUCCH, such as a countdown or count-up counter. Here the EGI field can be more than 1 bit. An example where the EGI is carried by 2 bits and where K_{LP}=3 is shown in FIG. 11.

DCI #1, DCI #2, DCI #3, DCI #4 and DCI #5 schedule PDSCH #1, PDSCH #2, PDSCH #3, PDSCH #4 and PDSCH #5 respectively with the associated HARQ-ACK originally scheduled to transmit in LP PUCCH #1 in Slot n+4. DCI #6 and DCI #7 schedule PDSCH #6 and PDSCH #7 where their HARQ-ACKs are carried by HP PUCCH #2. As in this example PUCCH #2 overlaps with PUCCH #1, their so their HARQ-ACKs are multiplexed into PUCCH #2 with the HP feedbacks.

In this example, the EGI is a counter that countdowns the last K_{LP}=3 downlink Grants associated with LP PUCCH #1, although it will be appreciated that the same technique may be used with an EGI that is configured to count up to the last transmission (e.g. set to a default value for previous transmissions and counting up for the last three downlink transmissions to be acknowledged).

The EGI indicates 00 (or any other default value) if the downlink Grant is not the last K_{LP}=3 downlink Grants associated with LP PUCCH #1. The UE misses DCI #4 and DCI #5 and it can be observed that without the EGI, the UE would wrongly assume that N_{LP}=3. However, since the UE receives DCI #3 where the EGI=11, it is aware that DCI #3 is the 3^{rd} last downlink Grant associated with PUCCH #1 based on the agreed counting mechanisms for the EGI. Accordingly, the UE can determine that it has missed some PDSCHs and more specifically that it has missed the last two downlink Grants, DCI #4 and DCI #5. Hence using the EGI, the UE is able to determine that Nip should be corrected to 5 and feedbacks N_{UCI}=7 bits consisting of 5 LP HARQ-ACKs and 2 HP HARQ-ACK.

It will be appreciated that in some cases, the EGI configured to be used as a counter for the last K_{LP} downlink transmissions may be used to count up rather than down, or effectively the change in any agreed pattern that the terminal and base station are both aware of. Accordingly, the UE is able not only to determine that a received downlink transmission is part of the last K_{LP} transmissions, but also the position of the received downlink transmission within the last K_{LP} transmissions, thereby providing a more robust determination of the number of downlink transmissions for which the base station or network will expect an acknowledgement feedback.

Likewise, the counter may not be counting up or down but rather be following any other pre-agreed pattern. For example, a two bit counter could have 10 as a default value for the previous transmissions and then take values 00, 11 and 01, in that order for the last three if K_{LP}=3 (and the same principles apply to other values for the number of bits and for K_{LP}. It will be appreciated that using increment or decrement from the first of the last K_{LP} transmissions to the last of these transmissions is expected to be a simple and efficient implementation, this is not the only type of counter considered herein.

For an n-bit EGI, the EGI can take 2″ values. As one value will typically be allocated for the transmissions which are not in the last K_{LP} transmissions, 2ⁿ−1 values remain available for the counter. As the n bits would be reserved in the signalling for the EGI, using the full 2ⁿ−1 possible values is expected to provide an optimal detection for an n-bit EGI. Accordingly, in such an example, the Kip value associated with an n-bit EGI can be set to 2ⁿ−1. For example, for a 2 bit EGI, Kip may be set to three.

The EGI may also be an n-bit indicator with n>2, however this is expected to provide a trade-off between signalling overhead and usefulness which is less beneficial. For example, with a 2-bit counter and K_{LP} set to 3, the terminal would have to miss the last 3 downlink transmissions for the EGI mechanism to fail. This is expected to be very unlikely (a 10⁻⁶ probability which is less than a URLLC BLER) and to be deemed acceptable. This is thus likely to be found acceptable in most current systems. If however the desired reliability expectation are greater, then having a longer EGI indicator may be helpful. For example, a 3 bit EGI would allow the EGI to be used to identify the last seven downlink transmissions. Missing all of these seven transmissions with the current BLER configuration would be associated with an likelihood of 10⁻¹⁴. This would be very unlikely and would be deemed satisfactory if for example the acknowledgement feedback (with or without multiplexing) has a desired BLER of 10⁻⁸ which would not always be achievable with a 2 bit EGI. The skilled person will thus understand that the size of the EGI may be determined based on desired error rates for the uplink transmissions and configured error rate for any of the downlink transmissions associated with the EGI.

While in most examples where acknowledgements are to be multiplexed between different priorities, the EGI is transmitted in association with the downlink transmissions associated with a LP uplink transmission, in another examples, the EGI is also transmitted in downlink Grant scheduling HP PUCCH. This allows the UE to increase the likelihood of having an accurate identification of the number of HP HARQ-ACKs are correct and/or that the total number of feedbacks to report is correct. It will however be appreciated that the EGI will most likely be transmitted only in association with the downlink transmissions having the higher risk of missing or unsuccessfully receiving the transmissions as this is likely to provide the most efficient use of the EGI signalling.

### Behaviour of Communications Device

In the present disclosure, a positive EGI is considered an indication that the last K_{LP} are being scheduled. This may be using any of the techniques discussed herein, such as a 1 bit indicator, or a counter. Any indication that identifies the last K_{LP} transmissions is thus considered a “positive” EGI. Likewise, a negative EGI is where the EGI indicates that the transmissions is not one of the last K_{LP} transmissions, e.g. the downlink Grant is not among the last K_{LP} downlink Grants. For example, using the 1 bit EGI example illustrated in FIG. 9, EGI=1 is a positive EGI and EGI=0 is a negative EGI.

Generally, and using the present techniques in combination with some of the current communications systems, the UE is able to better correct the number of HARQ-ACKs in a PUCCH carrying Type 2 CB, if it receives at least one positive EGI out of the last K_{LP} downlink Grants. In such cases, the UE can determine that it has missed one or more transmissions and which ones were missed. The acknowledgement feedback can be prepared accordingly, with negative feedback for the transmissions that the terminal had missed, e.g. the transmissions that the terminal was only able to detect through the use of the EGI.

In some cases, such as if the UE fails to detect any positive EGI, it will not be aware of the number of downlink Grants it has missed, only that it will be at least K_{LP} grants but it could be more. For example, if K_{LP}=1 and the UE fails to detect any positive EGI, the UE is not aware whether it failed to detect only the last downlink Grant or the last two downlink Grants (or more) for example. While in most current cases it is unlikely that the UE will fail to detect more than the last two downlink Grants with a PDCCH BLER target of 10⁻² but it is still possible and it will also be dependent on the reliability and robustness of the communications (e.g. of the BLER for the communications).

When the UE is not able to determine how many (and thus “which”) transmissions it has missed, the UE can be configured to operate in one or more different ways as discussed and illustrated below.

Cases in which the UE may not be able to determine how many or which transmissions have been missed include:
Missing all EGI, for example not receiving any Grant carrying or associated with an EGI, or
Missing some EGIs where the terminal is not able to determine which EGI was missed, in view of the EGI signalling pattern and of the pattern of received EGI (e.g. received Grant carrying or associated with an EGI).

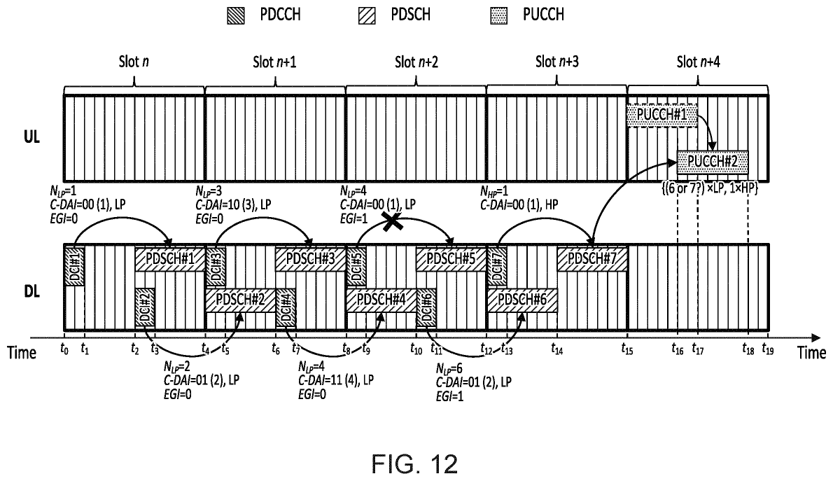

The latter case is illustrated for example in respect of FIG. 12. In this example the EGI is a 1 bit indicator, the UE may not be able to correct the number of HARQ-ACKs in a PUCCH carrying Type 2 CB, if it received some but not all the K_{LP} positive EGIs. In this example, DCI #1, DCI #2, DCI #3, DCI #4, DCI #5 and DCI #6 schedule PDSCH #1, PDSCH #2, PDSCH #3, PDSCH #4, PDSCH #5 and PDSCH #6 respectively with their corresponding HARQ-ACK scheduled in LP PUCCH #1 in Slot n+4. DCI #7 schedules PDSCH #7 with its HARQ-ACK scheduled in HP PUCCH #2, which collides with PUCCH #1 in Slot n+4.

In this example, the LP HARQ-ACK in PUCCH #1 is to be multiplexed with HP HARQ-ACK and carried in PUCCH #2 and the system if configured with K_{LP}=2 so that the last two transmissions or grants will be associated with an EGI. If the UE missed DCI #5 which is the penultimate downlink Grant for LP PUCCH #1 but receives DCI #6 which is associated with a positive DCI. The UE is able to recover the value N_{LP}=6 after receiving DCI #6 and to determine that DCI #5 was missed such that it knows that it missed one downlink grant.

However, the UE may not know whether EGI for DCI #5 was positive or negative such that it does not know if the last two DCIs were DCI #5 and DCI #6 or if there was another downlink Grant (e.g. DCI #7) associated with a positive EGI (EGI=1 in this example).

More generally, with a one bit indicator, if the terminal received missed at least one transmission before it receives the first positive EGI and received strictly less than K_{LP} positive EGI, the terminal may not be able to determine whether one or more of the missed at least one transmission were associated with a positive EGI to make up the difference between the number of received EGIs and the number of expected EGIs (e.g. K_{LP}), or if all of the missing positive EGI transmissions were after the last positive EGI transmission received.

Returning to the example of FIG. 12, the UE knows that it has missed a downlink transmission or grant associated with a positive EGI since the UE received only one positive EGI out of K_{LP}=2 EGIs. As a result, the UE may not know whether it should provide acknowledgement feedback for six transmissions (six LP HARQ-ACKs in this example) or for seven transmissions (so seven LP HARQ-ACKs in this example), since it does not know whether DCI #6 is the first (and penultimate with K_{LP}=2) downlink Grant or the last downlink Grant.

It will be appreciated that whether this situation might occur depend on the techniques used to signal the EGI. For example, if the EGI is signalled as a counter (e.g. counting up, down or following any other type of pattern), the UE is not only able to know that a transmission is one of the last K_{LP} one but also the position of the transmission in this series of K_{LP} transmissions. Accordingly, if a counter is used in the example of FIG. 12, the UE would be able to determine not that DCI #6 is one of the last two DCIs, but also that it is the DCI in second position of the last two. Accordingly, the UE would be able to reconstruct that DCI #5 was associated with a positive EGI and that no DCI #7 was expected.

And likewise, if DCI #5 was associated with a negative EGI and after that, the UE only received DCI #6 with a positive EGI, the UE would be able to use the counter to determine that DCI #6 was the first of the last two transmissions. Accordingly, the UE can determine that DCI #5 was not associated with a positive EGI and that the UE has missed DCI #7 which was the last one of the last two DCIs associated with a positive EGI.

It will thus be appreciated that whether this situation occur will be dependent on the agreed signalling technique for the EGI and on the specific combination of missed transmissions having a positive EGI or just before the transmissions having a positive EGI.

When the UE has a low confidence level in its determination of which transmissions have been missed, e.g. if the UE is unable to determine which transmissions (e.g. downlink control transmissions and/or downlink data transmissions such as DCI and/or PDSCHs) have been missed, or at least not with a degree of certainty high enough to be deemed acceptable, the UE can be configured to send acknowledgement feedbacks using one or more of the following techniques.

### Cancelling Feedback Reporting

In one example, the UE fails to detect any positive EGI and/or fails to detect all the K_{LP} positive 1 bit EGIs and/or is unable to determine how many transmissions were missed, the UE does not send acknowledgement feedback for the transmissions that were being tracked with a positive or negative EGI. This technique may be used whether the UE is expected to multiplex feedbacks associated with a low priority with feedbacks associated with a high priority or not.

For example, in a case without multiplexing, the UE might not send any feedback. The base station would be expected to treat this as negative feedback for all the transmissions and would then transmit them again.

For example, in a case where multiplexing is expected and the UE, when receiving transmissions to be acknowledged with a low priority, did not received any positive EGIs and/or is unable to determine which transmissions were missed, the UE does not perform multiplexing and report the HP feedback only. For example, the UE can drop or cancel the LP PUCCH transmission in favour of the HP PUCCH only. In other words, the UE would then revert back to a prioritisation similar to that found in systems such as those of Release 16.

In some cases, the EGI may be indicated using another field defined for other types of transmissions such as a Multiplexing Indicator, as discussed above. The UE can be configured to perform UCI multiplexing of different priorities (e.g. Layer 1 priorities) if the Multiplexing Indicator indicates that multiplexing is enabled in the downlink Grants associated with the HP PUCCH and for the downlink Grant(s) associated with the LP PUCCH. In such a case, the UE may be configured to multiplex the feedbacks only if it is able to determine how many low priority transmissions are to be acknowledge, or at least be able to make this determination with an acceptable degree of certainty.

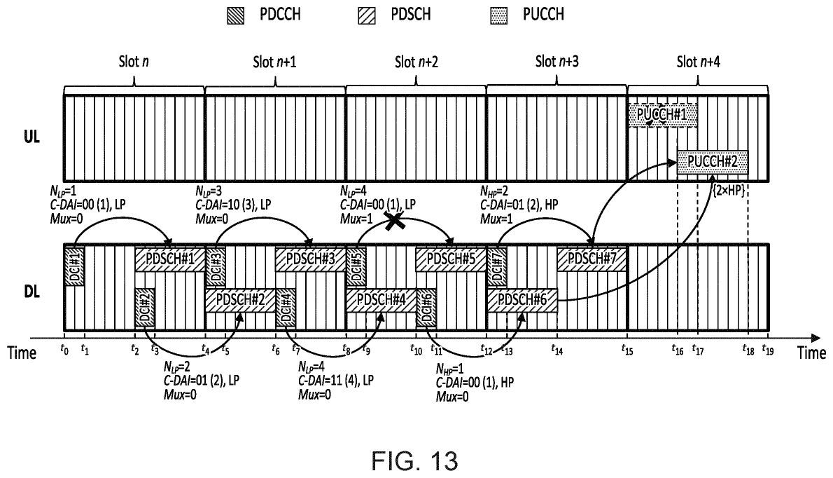

An example is shown in FIG. 13, which has the scenario similar to that in FIG. 10. Here the UE misses DCI #5, which is the last downlink Grant associated with LP PUCCH #1. In this example K_{LP}=1 and so the UE did not receive any positive EGI, i.e. a downlink Grant with Mux=1 and Priority Indicator=0. The UE then receives DCI #7 scheduling the HP PUCCH #2 and with Mux=1, thereby indicating to the UE should multiplex LP HARQ-ACK with HP HARQ-ACK into PUCCH #2. As per this embodiment, since the UE did not receive any positive EGI or Mux=1 in the downlink Grant associated with LP PUCCH #1, the UE performs prioritization, i.e. drops all the LP HARQ-ACKs and transmit only the 2 HP HARQ-ACKs in PUCCH #2.

This is because the UE can be configured to associate the determination that no positive EGI was received with a determination that the UE is unable to determine which transmissions were missed. This association is particularly useful in a case like this where K_{LP} is relatively low and the likelihood of missing at least K_{LP}+1 transmission is not considered as highly unlikely.

### Estimating the Number of Feedbacks to Report

In an embodiment when the UE fails to detect any positive EGI and/or is unable to determine which transmissions have been missed, the UE may be configured to estimate how many (and/or which) transmissions have been missed and to report feedback accordingly. This technique may also be used whether the UE is expected to multiplex feedbacks associated with a low priority with feedbacks associated with a high priority or not.

For example, if multiplexing is configured and the UE is configured to multiplex UCIs of different priorities (e.g. Layer 1 priorities), the UE can estimates the number of multiplexed HARQ-ACKs.

In some cases, this estimation may be based on an estimation of the number of LP HARQ-ACKs N_{LP}. This recognizes that, at least in current systems, the number of HP HARQ-ACKS N_{HP} is expected to be more reliably detected as the transmissions are scheduled using downlink Grants that meet the high priority communication requirements (e.g. URLLC reliability requirements) and thus scheduled using more reliable communication modes.

In one example, the estimation of the number of transmissions to report on (e.g. N_{LP} when the number LP feedback is potentially undetermined) is to increase this number (e.g. N_{LP}) by a predetermined value or amount (e.g. Nₑₛₜ).

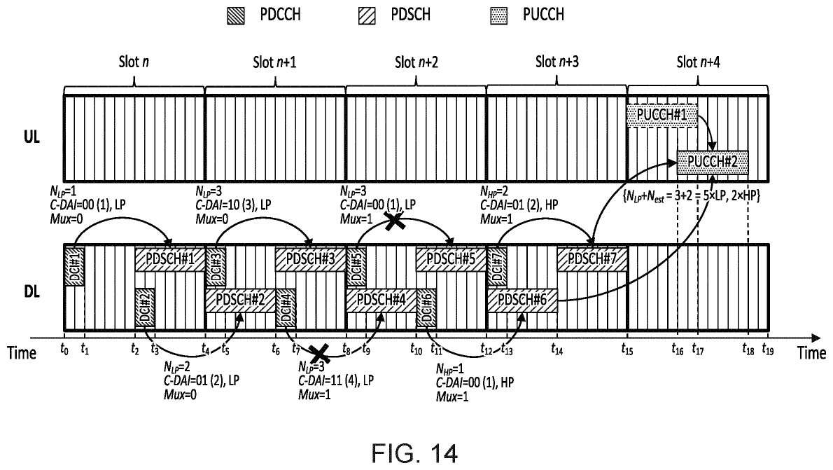

For example, FIG. 14 illustrates an implementation of this technique. This figure is based on a situation similar to that of FIG. 11, but where the EGI is indicated using a one bit indicator, such as a Multiplexing Indicator. In this example, the system is also configured with K_{LP}=2 and Nₑₛₜ=2. It is expected that in most cases, having the predetermined value (e.g. Nₑₛₜ) set to the same value as Kip is likely to be providing optimal results but this correlation is not necessary. The UE is scheduled five PDSCHs where their HARQ-ACKs are transmitted in LP PUCCH #1. DCI #6 and DCI #7 schedule PDSCH #6 and PDSCH #7, respectively, where their HARQ-ACKs are transmitted in HP PUCCH #2 which overlaps with PUCCH #1. DCI #6 and DCI #7 both indicate that UCI multiplexing of different L1 priorities is enabled, i.e. Mux=1.

In this example situation, the UE did not receive any positive EGI, as it missed DCI #4 and DCI #5. In accordance with this example, when the UE missed all EGIs, the UE estimates the total number of LP HARQ-ACK by N_{LP}+Nₑₛₜ. The UE's internal counter has an N_{LP}=3 which is based on the last downlink Grant DCI #3 and since Nₑₛₜ=2, the UE will report feedbacks for five LP HARQ-ACKs and for two HP HARQ-ACKs in PUCCH #2. In this case, the LP HARQ-ACKs for the assumed missed PDSCH, i.e. PDSCH #4 and PDSCH #5, will be sent as negative feedbacks (NACKs).

Such a configuration uses the fact that the value K_{LP} is expected to be based on a maximum number of successive missed transmissions that can reasonably be expected. Accordingly, the UE would be highly unlikely to be missing more than K_{LP}+1 DCIs in a row. Accordingly, the UE would be able to make a reasonable assumption that if no EGI was received, then Kip DCIs were probably missed rather than more (if less, at least one EGI would have been detected).

In one implementation, the value of Nₑₛₜ is RRC configured.

Alternatively or additionally, the value of Nₑₛₜ may be fixed or determined based on pre-agreed mechanisms, for example based on an agreed convention or standard between the UE and gNB.

Alternatively or additionally, the value of Nₑₛₜ can be determined based on the value K_{LP} identifying the number of transmissions associated with a (positive) EGI, for example having a (positive) EGI in the corresponding downlink control information (e.g. DCI). As K_{LP} is set as the number of consecutive last downlink Grants that will be associated with an EGI marking the transmissions as being the last K_{LP} ones and that this value is expected to be selected so that it is unlikely that the UE would miss more than K_{LP} DCI or transmissions. Accordingly, if the UE does not detect any positive EGI, it is unlikely it will miss more than K_{LP} downlink Grants and so the estimated number of HARQ-ACK is increased by Nₑₛₜ=K_{LP}.

In addition to not receiving any positive EGIs, as described previously, the UE may sometimes receive some EGI and may not be able to determine with an acceptable level of certainty the number of missed downlink Grants, for example where EGI is a one bit field. In such a case, the estimation of number of transmissions to acknowledge can be rounded up to the nearest value of a set of possible N_{LP} values. That is, a set of N_{LP} values {N_{LP-1}, N_{LP-2}, N_{LP-3}, . . . } can be defined (e.g. predefined or fixed, or defined using RRC signalling) and the UE can select the nearest possible value in the set. It will be appreciated that, in this implementation, this rounding up would only be used in cases where the UE did not receive all the K_{LP} positive EGIs and is unable to determine how many transmissions were missed (and/or when it does not detect any positive EGI). In other cases, the UE can be configured to use the number of missed transmissions as detected using the EGI and without rounding it up to this nearest value. Accordingly, the number of times where the base station would have to perform blind decoding of the uplink transmission would be reduced as in many cases the UE would be able to determine which transmissions were missed and to report with the correct number of feedbacks.

### RRC Configuration to Drop or Estimate

In an example, the UE may be configured via RRC signalling with which behaviour or technique to implement when it fails to detect any positive EGI and/or when it is unable to determine how many transmissions were missed (see above). For example, the UE may be configured to drop (cancel) the feedback transmission, or to estimate the number of feedbacks to send via RRC signalling. The UE may also be configured to implement one technique or behaviour without multiplexing and to implement another when multiplexing is implemented and activated, for example UCI multiplexing of different L1 priorities is enabled.

For example, a UE may be configured to estimate the number of missed transmissions and to report the feedbacks based on the estimated number when the feedbacks are not to be multiplexed. The same UE may also be configured to cancel the transmissions of the LP feedbacks if no EGIs were received and/or of the number of missed transmissions cannot be accurately determined, when the LP feedback if configured to be multiplexed with the HP feedbacks. For example, the estimation might be expected to be accurate in a majority of cases such that it might be worth attempting to rely on this estimation when reporting LP feedback. On the other hand, this majority of cases may not be sufficiently large that it can provide a reliability level that is high enough for a high priority transmission. In this case, the risk of lowering the reliability of the HP feedback transmissions by multiplexing them with less reliable feedbacks may be considered as an unacceptable risk and the UE will not multiplex its low priority feedback unless it is able to determine the number of transmissions associated with a low priority feedback.

### Methods

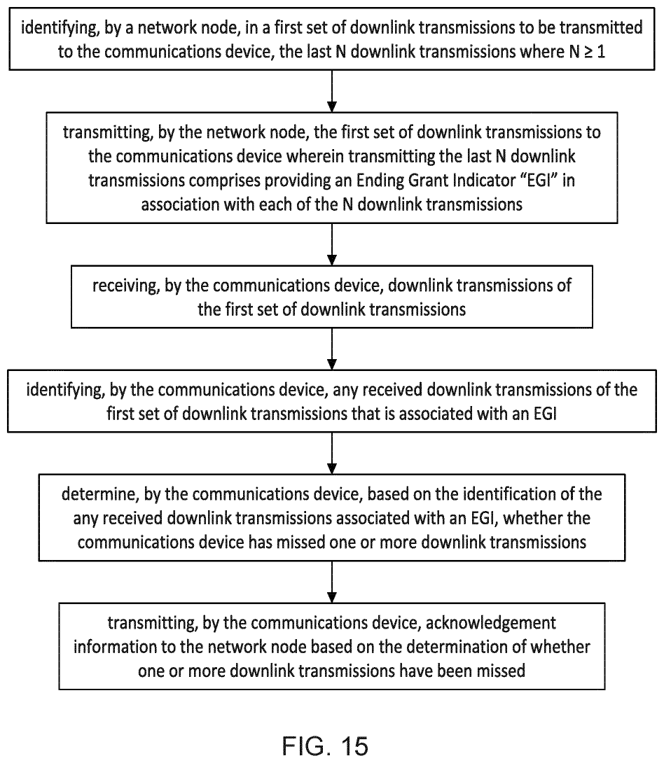

An example method in accordance with the present disclosure is illustrated in FIG. 15 and discussed below.

The method can be implemented in a system for communicating in a mobile communications network where the network comprising a network node and a communications device. The base station or gNB above and the UE or terminal above are (non-exhaustive) examples of network nodes and communications devices, respectively.

The network node is configured to provide a wireless interface to communicate with the communications device and is further configured to identify, in a first set of downlink transmissions to be transmitted to the communications device, the last N downlink transmissions where N is greater than or equal to 1, and to transmit the first set of downlink transmissions to the communications device wherein transmitting the last N downlink transmissions comprises providing an Ending Grant Indicator “EGI” in association with each of the N downlink transmissions.

The communications device is configured to receive downlink transmissions of the first set of downlink transmissions (which may be fewer than those transmitted by the network node, if for example the communications device missed a Grant) and identify any received downlink transmissions of the first set of downlink transmissions that is associated with an EGI. In some case, the Communications device will find N identified transmissions, in some cases none and in other cases a value N_{received} between 0 and N.

Based on the identification of the any received downlink transmissions associated with an EGI, the communications device can determine whether it has missed one or more downlink transmissions of the first set of downlink transmissions, for example if N_{received}<N. The communications device can then transmit acknowledgement information to the network node based on the determination of whether one or more downlink transmissions have been missed.

In some cases, the network node is configured to provide an EGI in association with each of the N downlink transmissions by including an EGI in a downlink control signal associated with the each of the N downlink transmissions. For example, the downlink control signal may be or comprise a downlink grant for the each of the N downlink transmissions.

Likewise, the communications node maybe configured to identify any received downlink transmissions of the first set of downlink transmissions that is associated with an EGI by detecting that the any received downlink transmissions have an EGI included in a downlink control signal associated with the any received downlink transmissions, where the downlink control signal may be or comprise a downlink grant for any received downlink transmissions.

In some examples, the network node is configured to transmit the EGI as a one bit indicator, the one bit indicator being set to a first value for any downlink transmission of the first set of downlink transmissions which is not in the last N downlink transmissions and being set to a second value, different from the first value, for the last N downlink transmissions.

Likewise, the communications node maybe configured to identify any received downlink transmissions of the first set of downlink transmissions that is associated with an EGI by detecting that the any received downlink transmissions are associated with an EGI having the second value indicating a positive EGI, wherein the remaining downlink transmissions of the first set of downlink transmissions are associated with an EGI having the first value indicative a negative EGI (e.g. an EGI field providing a “no EGI” indication), wherein the EGI is provided as a one bit indicator.

In some instances, the network node may be configured to transmit the EGI as n-bit counter for counting the last N downlink transmissions, wherein n≥1. It may be noted that the counter may in many cases have n≥2 and that in cases where n=1, the system may, from one perspective, be considered as similar to the example above where the EGI is provided using a one bit filed, where one value indicates a (positive) EGI and the other indicates no EGI or a negative EGI.

For example, such a counter may incrementally count each of the last N downlink transmissions or may decrementally count each of the last N downlink transmissions.

As above, it will be appreciated that if the EGI is provided in this manner, the communications device will be configured to determine whether it has missed one or more downlink transmissions using the counter value for the any identified received downlink transmissions, namely the downlink transmissions that have been received and that are associated with an EGI (e.g. a positive EGI in the form of a counter). In some cases, the EGI may be provided by configuring the value of a field of a Downlink Control Information “DCI” signal associated with the first set of downlink transmissions, wherein the field is used to configure transmissions other than the first set of downlink transmissions. For example, the field may be used to configure transmissions associated with a high priority while the first set of downlink transmissions is associated with a low priority, such that it would not normally be expected to be configured using this field. One example may be a case where the field is a Multiplexing Indicator indicating whether the acknowledgement information for transmissions associated with a high priority will be multiplexed with acknowledgement information for transmissions associated with a low priority.

This may be indicated in respect of transmissions having high priority feedback information and thus not used in respect of the first set of downlink transmissions, if it is associated with low priority feedback information.

In some implementations, the network node can identify a second set of downlink transmissions to be transmitted to the communications device. The network node can provide the EGI (in association with the each of the N downlink transmissions) when the network node determines that the communications device is configured to multiplex the acknowledgement information for the first set with the acknowledgement information for the second set. This may be provided at least in these cases as they may be associated with a higher risk of lower priority and/or reliability transmissions reducing the reliability of higher priority transmissions.

Likewise, in some examples, the communications device may be configured to identify a second set of downlink transmissions to be received from the communications device. The communications device may then be configured to identify the any downlink transmissions of the first set of downlink transmissions that was received in association with an EGI when the communications device determines that the communications device is configured to multiplex the acknowledgement information for the first set and the acknowledgement information for the second set. For example, if multiplexing takes place, the communications device may determine to detect and use the EGI to try to report acknowledgement feedback accordingly, with hopefully improved information about how many feedbacks to send.

In the cases above with a first set and a second set of transmissions, the first set of downlink transmissions may be associated with a low priority and the second set of downlink transmissions may be associated with a high priority.

More generally, the first set of downlink transmissions are associated with one of a high priority and a low priority, for example at the Physical layer.

In some examples, the communications device is configured, if it determines that the communications device has missed one or more downlink transmissions of the first downlink transmissions, to attempt to identify a number of downlink transmissions of the first set of downlink transmissions have been missed. For example, the communications device may make this identification based on a comparison of the number of transmissions actually received which are associated with an EGI and the expected number of transmissions received which are associated with an EGI and, optionally based on a transmission numbering system (e.g. DAI).

For example, the communications devices may be configured, if it is unable to identify the number of downlink transmissions of the first set of downlink transmissions have been missed, not to transmit acknowledgement information for the first set of downlink transmissions. In case there is multiplexing being configured, the communications devices would not send the low priority feedback and would thus not multiplex the low priority feedback with the high priority feedback (e.g. with a view to avoiding reducing the reliability of the high priority reporting).

In some instances, the communications device can, if the identification of the any received downlink transmissions associated with an EGI identifies no received downlink transmissions associated with an EGI, not transmit acknowledgement information for the first set of downlink transmissions (i.e. transmit no acknowledgement information for the first set of downlink transmissions). For example, if the communications device received no (i.e. zero) EGIs for the first set of downlink transmissions, where it is associated with low priority acknowledgements, it may be configured not to send any acknowledgement in respect of the first set. This may for example mean that the communications device may not multiplex the low priority acknowledgement information with high priority acknowledgement information if it was otherwise configured to do so. As previously discussed, this configuration of the communications device may be activated or deactivated using signalling, such as RRC signalling.

In some cases, the communications device may be configured, if it determines that the communications device has missed one or more downlink transmissions, to estimate how many downlink transmissions of the first set of downlink transmissions have been missed. It may do using the number of EGI notified for the first set and, optionally based on a transmission numbering system (e.g. DAI).

For example, the communications device may be configured to estimate how many downlink transmissions of the first set of downlink transmissions have been missed by adding a predetermined first number to a number of known transmissions of the first set of downlink transmissions. It should be noted that the number of known transmissions might be greater than the number of received transmissions. If for example the terminal is able to determine that it has received two transmissions numbered 1 and 3 and only one of two expected EGIs, it can determine that (1) it has missed transmission number 2 and (2) that it has missed one transmission associated with an EGI. Accordingly, the number of known transmissions is three (transmissions numbered 1 to 3) even though the number of received transmissions is two. It will be appreciated that in some cases, e.g. where the number of known transmissions is different from the number of received transmissions, the number of known transmission may be based on a transmission number system (e.g. DAI) used for the transmissions.

In some cases, the predetermined first number is equal to N, the number of EGI or of transmissions associated with an EGI.

In some implementations, the first set of downlink transmissions is a first set of downlink transmissions to be acknowledged together in an uplink transmission by the communications device. For example, all acknowledgement information is sent using a single uplink transmissions, which may be an uplink control transmission (e.g. PUCCH transmission) or an uplink data transmission (e.g. PUSCH). In some cases, they may be multiplexed with additional acknowledgment information from another set of downlink transmissions for example.

In some instances, the network node can be further configured to transmit a transmission counter associated with each of the transmitted downlink transmission of the first set of downlink transmissions, wherein the transmission counter is incremented with each transmitted downlink transmission of the first set of downlink transmissions. Such a transmission numbering system can assist the communications device in determining whether it has missed any transmission of the first set (whether the missed transmissions are part of the last N ones or not). Optionally, in some implementations, the transmission counter is incremented until it reaches a maximum value and is reset to an initial value at the next increment after the maximum value, which can provide a wrap-around counter.

For example, the transmission counter for each of the first set of downlink transmissions may be transmitted in a downlink control signal associated with the each of the first set of downlink transmissions, wherein, optionally, the downlink control signal may also comprise a downlink grant for the each of the first set of downlink transmissions. In some cases, the transmission counter may be transmitted with the EGI, for example as transmission counter field in the downlink grant for each transmission of the first set, where the EGI is provided in another field of the downlink grant.

When such a transmission counter is used, the communications device may determine whether the communications device has missed one or more downlink transmissions based on the identification of the any received downlink transmissions associated with an EGI (e.g. based on how many of such any received downlink transmissions associated with an EGI were received or identified) and on the transmission counter.

In some implementations, the network node can be configured to determine a first set of resources for receiving the acknowledgement information for the first set of downlink transmissions based on at least the number of transmissions in the first set of downlink transmissions, and to attempt to receive the acknowledgement information (for the first set downlink transmissions and from the communications device) in the first set of resources. In this system, the communications device may be configured to determine an expected number of transmissions in the first set of downlink transmissions based on the identification of the any received downlink transmissions associated with an EGI, determine a second set of resources for transmitting the acknowledgement information for the first set of downlink transmissions based on at least the expected number of transmissions in the first set of downlink transmissions, and transmit acknowledgement information to the network node using the second set of resources.

In such a system where the resources to be used for transmitting (and thus receiving) the acknowledgement information are selected based on the number of downlink transmissions to acknowledge, discrepancies in the number of transmitted identified by the network node and determined by the communications device might result in the network node and communications device having different determinations of which resources to use. In turn, this might result in the acknowledgement information not being successfully transmitted.

In some cases, the communications device can be configured to determine whether the communications device has missed one or more downlink transmissions based on a comparison of a number of identified received downlink transmissions with the number N of downlink transmissions of the first set of downlink transmissions expected to be associated with an EGI.

In some instances, the parameter N may configured based on one or more of Radio Resource Control “RRC” signalling to the communications device and a predetermined value, such as a value predefined in an agreed manner such as in a standard. It may also be configured using both techniques, with the value taking one of a limited number of possible values where the selected one is identified using control signalling such as RRC signalling.

### Further Considerations

As mentioned above, the EGI may be associated with the last K_{LP} transmissions to assist the UE in determine how many and which transmissions might have been missed. It will also be appreciated that while the case of low priority and high priority feedbacks will be multiplexed represent one of the main use cases, the techniques and teachings discussed herein are not limited to such a multiplexing use case, as mentioned above. Accordingly, in some cases, the marking of some transmissions as being the last one may be a number K of last transmissions, regardless of the priority and/or regardless of whether the communications have any priority or L1 priority associated with them for the feedback transmissions. Therefore the teachings made in respect of the K_{LP} configuration can equally be applied to a K configuration.

Also, the number K_{LP} will identify a number of downlink transmissions that the terminal will acknowledge, for example to help the UE in determining the expected number of acknowledgment feedbacks. It will thus be appreciated that in a case where there is a 1:1 relationship between the number of downlink transmissions to acknowledge with a separate acknowledgement feedback and the number of downlink control information (e.g. DCI) such as downlink Grants that schedule such transmissions, K_{LP} will also correspond to the number of Grants. In cases where the terminal receives the grant, it will then detect that a downlink transmission was sent (and thus not missed in that respect), whether it was successfully received, which will result in an ACK feedback, or unsuccessfully received, which will result in a NACK feedback. As a result, cases where the UE misses a downlink transmission are expected to be cases in which the UE does not receive or detect the Grant for the downlink transmission. With a 1:1 relationship between grants and transmissions (e.g. PDSCHs), the UE will miss as many transmissions as it misses grants.

It will be appreciated that the K_{LP} or K number may sometimes be viewed as being defined in respect of a number of downlink transmissions scheduled, in respect of a number of downlink Grants scheduling such transmissions and/or in respect of a number of acknowledgement feedbacks to be transmitted.

The present disclosure assumes in many cases that the feedbacks will be send in an uplink control transmission (e.g. PUCCH transmission). However, it will be appreciated that the same teachings and techniques apply equally to uplink data transmissions (e.g. PUSCH transmissions). In some cases, the acknowledgement feedback will be sent in a PUSCH transmissions and the same techniques may be used, in particular if having an incorrect number of feedbacks to report can lead to selecting a different set of resources compared to what the base station expect. In other words, the uplink transmissions may be any suitable type of transmission, such as an uplink control transmission (e.g. PUCCH) or an uplink data transmission such as a PUSCH.

In many cases, the base station may want to identify a plurality of last transmissions that it is sending (e.g. the last three transmissions as illustrated in FIG. 11) but in some cases, it may wish to identify the last transmission only (e.g. as illustrated in FIG. 13). The skilled person can configure the number of transmissions to associate with an EGI based on a number of factors, such as the reliability of the transmission and the signalling overhead impact associated with the configured number.

Also, the present invention has been presented in the context of a system where a transmission counter is used (e.g. DAI or C-DAI) which wraps around. The same principles will also apply if the counter does not wrap around or is not expected to wrap around in most cases or in some cases.

Depending on the perspective, the control information or control signal (e.g. DCI) associated with a downlink transmissions (e.g. PDSCH) may be considered as being part of the transmission or as being a separate transmission associated with the transmission. Either way, the control information is associated with a transmission from a network node to a terminal device. And as mentioned above, it will also be appreciated that in the present disclosure, the teachings and techniques applied to DCIs and/or PDSCHs can be equally applied to downlink control information or downlink grant information and to downlink transmissions such as downlink data transmissions. Likewise, teachings and techniques applied to PUCCH and PUSCH can be equally applied to uplink control transmissions or uplink acknowledgement feedback transmissions and uplink transmissions such as uplink data transmissions.

The term resources or resource can refer to any suitable set of time and frequency resources to be used to transmit signals on the wireless interface. This may be measured in some cases based on a resource blocks, slots, frames or any other resource unit deemed appropriate. For example, the discussions and examples provided herein where the timing of a transmission (uplink and/or downlink) is measured in a slot or sub-slot may be equally applied to examples where a different time unit is used, such as a frame, sub-frame, etc.

While reference has sometimes been made to particular sets of standards, for example different release versions (“Release 15”, “Release 16”, etc.), it will be appreciated that this is done for illustrative purposes only and the teachings and techniques of the present invention are not limited to these particular systems but rather these systems are used to illustrate which limitations that can be found in some systems and why.

Additionally, the method steps discussed herein may be carried out in any suitable order. For example, steps may be carried out in an order which differs from an order used in the examples discussed above or from an indicative order used anywhere else for listing steps (e.g. in the claims), whenever possible or appropriate. Thus, in some cases, some steps may be carried out in a different order, or simultaneously or in the same order. So long as an order for carrying any of the steps of any method discussed herein is technically feasible, it is explicitly encompassed within the present disclosure.

As used herein, transmitting information or a message to an element may involve sending one or more messages to the element and may involve sending part of the information separately from the rest of the information. The number of “messages” involved may also vary depending on the layer or granularity considered. For example transmitting a message may involve using several resource elements in an LTE or NR environment such that several signals at a lower layer correspond to a single message at a higher layer. Also, transmissions from one node to another may relate to the transmission of any one or more of user data, system information, control signalling and any other type of information to be transmitted.

Also, whenever an aspect is disclosed in respect of an apparatus or system, the teachings are also disclosed for the corresponding method and for the corresponding computer program. Likewise, whenever an aspect is disclosed in respect of a method, the teachings are also disclosed for any suitable corresponding apparatus or system. Additionally, it is also hereby explicitly disclosed that for any teachings relating to a method or a system where it has not been clearly specified which element or elements are configured to carry out a function or a step, any suitable element or elements that can carry out the function can be configured to carry out this function or step. For example, any one or more of a terminal device or network node may be configured accordingly if appropriate, so long as it is technically feasible and not explicitly excluded.

Whenever the expressions “greater than” or “smaller than” or equivalent are used herein, it is intended that they discloses both alternatives “and equal to” and “and not equal to” unless one alternative is expressly excluded.

It will be appreciated that while the present disclosure has in some respects focused on implementations in a 5G or NR network as such a network is expected to provide the primary use case at present, the same teachings and principles can also be applied to other wireless telecommunications systems. Thus, even though the terminology used herein is generally the same or similar to that of the 5G (or LTE) standards, the teachings are not limited to the present versions 5G (or LTE) and could apply equally to any appropriate arrangement not based on 5G/LTE, for example any arrangement possibly compliant with any future version of an LTE, 5G or other standards-defined by the 3GPP standardisation groups or by other groups. Accordingly, the teaching provided herein using 3GPP, LTE and/or 5G/NR terminology can be equally applied to other systems with reference to the corresponding functions. For example, references to HARQ-ACK or DCI can be more generally understood as references to acknowledgements (positive or negative) or control information relating to the downlink.

It is noteworthy that where a “predetermined” element is mentioned, it will be appreciated that this can in some cases include a configurable element, wherein the configuration can be done by any combination of a manual configuration by a user or administrator or a transmitted communication, for example from the network or from a service provider (e.g. a device manufacturer, an OS provider, etc.).

Techniques discussed herein can be implemented using a computer program product or computer readable medium, comprising for example computer-readable instructions which can be executed by a computer, for carrying a method according to the present disclosure. Such a computer readable medium may be a non-transitory computer-readable storage medium with an executable program stored thereon, wherein the program instructs a microprocessor to perform said method. Additionally, or alternatively, the techniques discussed herein may be realised at least in part by a computer readable communication medium that carries or communicates code in the form of instructions or data structures and that can be accessed, read, and/or executed by a computer.

In other words, any suitable computer readable medium may be used, which comprises instructions and which can for example be a transitory medium, such as a communication medium, or a non-transitory medium, such as a storage medium. Accordingly, a computer program product may be a non-transitory computer program product.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely illustrative examples of the present disclosure. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered clauses:
Clause 1. A system for communicating in a mobile communications network comprising a network node and a communications device, the network node being configured to provide a wireless interface to communicate with the communications device,
wherein the network node is configured to:
identify, in a first set of downlink transmissions to be transmitted to the communications device, the last N downlink transmissions where N is greater than or equal to 1, and
transmit the first set of downlink transmissions to the communications device wherein transmitting the last N downlink transmissions comprises providing an Ending Grant Indicator “EGI” in association with each of the N downlink transmissions; and
wherein the communications device is configured to:
receive downlink transmissions of the first set of downlink transmissions,
identify any received downlink transmissions of the first set of downlink transmissions that is associated with an EGI,
determine, based on the identification of the any received downlink transmissions associated with an EGI, whether the communications device has missed one or more downlink transmissions, and
transmit acknowledgement information to the network node based on the determination of whether one or more downlink transmissions have been missed.
Clause 2. The system of any preceding Clause wherein the network node is configured to provide an EGI in association with each of the N downlink transmissions by including an EGI in a downlink control signal associated with the each of the N downlink transmissions.
Clause 3. The system of Clause 2 wherein the downlink control signal comprises a downlink grant for the each of the N downlink transmissions.
Clause 4. The system of any preceding Clause wherein the network node is configured to transmit the EGI as a one bit indicator, the one bit indicator being set to a first value for any downlink transmission of the first set of downlink transmissions which is not in the last N downlink transmissions and being set to a second value, different from the first value, for the last N downlink transmissions.
Clause 5. The system of any preceding Clause wherein the network node is configured to transmit the EGI as n-bit counter for counting the last N downlink transmissions.
Clause 6. The system of Clause 5 wherein the counter incrementally counts each of the last N downlink transmissions or decrementally counts each of the last N downlink transmissions.
Clause 7. The system of any preceding Clause, wherein the network node is configured to provide the EGI by configuring a field of a Downlink Control Information “DCI” associated with the first set of downlink transmissions, wherein the field is used to configure transmissions other than the first set of downlink transmissions.
Clause 8. The system of Clause 7 wherein the first set of downlink transmissions is associated with a low priority and wherein the field is used to configure transmissions associated with a high priority.
Clause 9. The system of Clause 7 or 8 wherein the field is a Multiplexing Indicator indicating whether the acknowledgement information for transmissions associated with a high priority will be multiplexed with acknowledgement information for transmissions associated with a low priority.
Clause 10. The system of any preceding Clause
wherein the network node is further configured to identify a second set of downlink transmissions to be transmitted to the communications device, and
wherein the network node is configured to provide the EGI in association with each of the N downlink transmissions when the network node determines that the communications device is configured to multiplex the acknowledgement information for the first set and the acknowledgement information for the second set.
Clause 11. The system of any preceding Clause
wherein the communications device is further configured to identify a second set of downlink transmissions to be received from the network node, and
wherein the communications device is configured to identify the any downlink transmissions of the first set of downlink transmissions that was received in association with an EGI when the communications device determines that the communications device is configured to multiplex the acknowledgement information for the first set and the acknowledgement information for the second set.
Clause 12. The system of any one of Clauses 10-11 wherein the first set of downlink transmissions is associated with a low priority and the second set of downlink transmissions is associated with a high priority.
Clause 13. The system of any preceding Clause wherein the first set of downlink transmissions are associated with one of a high priority and a low priority.
Clause 14. The system of any preceding Clause wherein the communications device is further configured, if it determines that the communications device has missed one or more downlink transmissions, to attempt to identify a number of downlink transmissions of the first set of downlink transmissions have been missed.
Clause 15. The system of Clause 14 wherein the communications device is configured, if the communications device is not able to identify the number of downlink transmissions of the first set of downlink transmissions have been missed, not to transmit acknowledgement information for the first set of downlink transmissions.
Clause 16. The system of any preceding Clause wherein, the communications device is configured, if the identification of the any received downlink transmissions associated with an EGI identifies no received downlink transmissions associated with an EGI, not to transmit acknowledgement information for the first set of downlink transmissions.
Clause 17. The system of any preceding Clause, wherein the communications device is configured, if it determines that the communications device has missed one or more downlink transmissions, to estimate how many downlink transmissions of the first set of downlink transmissions have been missed.
Clause 18. The system of Clause 17 wherein the communications device is configured to estimate how many downlink transmissions of the first set of downlink transmissions have been missed by adding a predetermined first number to a number of known transmissions of the first set of downlink transmissions, wherein, optionally, the predetermined first number is equal to N.
Clause 19. The system of any preceding Clause, wherein the first set of downlink transmissions is a first set of downlink transmissions to be acknowledged together in an uplink transmission by the communications device.
Clause 20. The system of any preceding Clause, wherein the network node is further configured to transmit a transmission counter associated with the each transmitted downlink transmission of the first set of downlink transmissions, wherein the transmission counter is incremented after each transmitted downlink transmission of the first set of downlink transmissions wherein, optionally, the transmission counter is incremented until it reaches a maximum value and is reset to an initial value at the next increment after the maximum value.
Clause 21. The system of Clause 20 wherein the transmission counter for each of the first set of downlink transmissions is transmitted in a downlink control signal associated with the each of the first set of downlink transmissions.
Clause 22. The system of Clause 20 or 21 wherein the downlink control signal comprises a downlink grant for the each of the first set of downlink transmissions.
Clause 23. The system of any one of Clauses 20 to 22 wherein the communications device is configured to determine whether the communications device has missed one or more downlink transmissions based on the identification of the any received downlink transmissions associated with an EGI and on the transmission counter.
Clause 24. The system of any preceding Clause,
wherein the network node is configured to:
determine a first set of resources for receiving the acknowledgement information for the first set of downlink transmissions based on at least the number of transmissions in the first set of downlink transmissions, and
attempt to receive the acknowledgement information in the first set of resources; and
wherein the communications device is configured to:
determine an expected number of transmissions in the first set of downlink transmissions based on the identification of the any received downlink transmissions associated with an EGI, determine a second set of resources for transmitting the acknowledgement information for the first set of downlink transmissions based on at least the expected number of transmissions in the first set of downlink transmissions, and
transmit acknowledgement information to the network node using the second set of resources.
Clause 25. The system of any preceding Clause wherein the communications device is configured to determine whether the communications device has missed one or more downlink transmissions based on a comparison of a number of identified received downlink transmissions with the number N of downlink transmissions of the first set of downlink transmissions expected to be associated with an EGI.
Clause 26. The system of any preceding Clause wherein N is configured based on one or more of Radio Resource Control “RRC” signalling to the communications device and a predetermined value.
Clause 27. A method for use in a mobile communications network comprising a network node and a communications device, the network node being configured to provide a wireless interface to communicate with the communications device, the method comprising:
identifying, by the network node and in a first set of downlink transmissions to be transmitted to the communications device, the last N downlink transmissions where N is greater than or equal to 1; transmitting, by the network node, the first set of downlink transmissions to the communications device wherein transmitting the last N downlink transmissions comprises providing an Ending Grant Indicator “EGI” in association with each of the N downlink transmissions;
receiving, by the communications device, downlink transmissions of the first set of downlink transmissions;
identifying, by the communications device, any received downlink transmissions of the first set of downlink transmissions that is associated with an EGI;
determining, by the communications device and based on the identification of the any received downlink transmissions associated with an EGI, whether the communications device has missed one or more downlink transmissions; and
transmitting, by the communications device, acknowledgement information to the network node based on the determination of whether one or more downlink transmissions have been missed.
Clause 28. The method of Clause 27 wherein the network node providing the EGI in association with each of the N downlink transmissions comprises the network node including an EGI in a downlink control signal associated with the each of the N downlink transmissions.
Clause 29. The method of Clause 28 wherein the downlink control signal comprises a downlink grant for the each of the N downlink transmissions.
Clause 30. The method of any one of Clauses 27 to 29, further comprising transmitting, by the network node, the EGI as a one bit indicator, the one bit indicator being set to a first value for any downlink transmission of the first set of downlink transmissions which is not in the last N downlink transmissions and being set to a second value, different from the first value, for the last N downlink transmissions.
Clause 31. The method of any one of Clauses 27 to 30, further comprising transmitting, by the network node, the EGI as n-bit counter for counting the last N downlink transmissions.
Clause 32. The method of Clause 31 wherein the counter incrementally counts each of the last N downlink transmissions or decrementally counts each of the last N downlink transmissions.
Clause 33. The method of any one of Clauses 27 to 32, wherein providing the EGI comprises configuring a field of a Downlink Control Information “DCI” associated with the first set of downlink transmissions, wherein the field is also used to configure transmissions other than the first set of downlink transmissions.
Clause 34. The method of Clause 33 wherein the first set of downlink transmissions is associated with a low priority and wherein the field is used to configure transmissions associated with a high priority.
Clause 35. The method of Clause 33 or 34 wherein the field is a Multiplexing Indicator indicating whether the acknowledgement information for transmissions associated with a high priority will be multiplexed with acknowledgement information for transmissions associated with a low priority.
Clause 36. The method of any one of Clauses 27 to 35, further comprising:
identifying, by the network node, a second set of downlink transmissions to be transmitted to the communications device,
wherein providing the EGI comprises providing the EGI in association with each of the N downlink transmissions when the network node determines that the communications device is configured to multiplex the acknowledgement information for the first set and the acknowledgement information for the second set.
Clause 37. The method of any one of Clauses 27 to 36, further comprising:
identifying, by the communications device, a second set of downlink transmissions to be received from the network node, and
wherein the communications device identifies the any downlink transmissions of the first set of downlink transmissions that was received in association with an EGI when the communications device determines that the communications device is configured to multiplex the acknowledgement information for the first set and the acknowledgement information for the second set.
Clause 38. The method of Clause 36 or 37, wherein the first set of downlink transmissions is associated with a low priority and the second set of downlink transmissions is associated with a high priority.
Clause 39. The method of any one of Clauses 27 to 38, wherein the first set of downlink transmissions are associated with one of a high priority and a low priority.
Clause 40. The method of any one of Clauses 27 to 39, further comprising the communications device attempting, if it determines that the communications device has missed one or more downlink transmissions, to identify a number of downlink transmissions of the first set of downlink transmissions have been missed.
Clause 41. The method of Clause 40 further comprising the communications device, if the communications device is not able to identify the number of downlink transmissions of the first set of downlink transmissions have been missed, not transmitting acknowledgement information for the first set of downlink transmissions.
Clause 42. The method of any one of Clauses 27 to 41, further comprising, if the identification of the any received downlink transmissions associated with an EGI identifies no received downlink transmissions associated with an EGI, the communications device not transmitting acknowledgement information for the first set of downlink transmissions.
Clause 43. The method of any one of Clauses 27 to 42, further comprising the communications device, if it determines that the communications device has missed one or more downlink transmissions, estimating how many downlink transmissions of the first set of downlink transmissions have been missed.
Clause 44. The method of Clause 43 wherein the communications device estimating how many downlink transmissions of the first set of downlink transmissions have been missed comprises the communications device adding a predetermined first number to a number of known transmissions of the first set of downlink transmissions, wherein, optionally, the predetermined first number is equal to N.
Clause 45. The method of any one of Clauses 27 to 44, wherein the first set of downlink transmissions is a first set of downlink transmissions to be acknowledged together in an uplink transmission by the communications device.
Clause 46. The method of any one of Clauses 27 to 45, further comprising transmitting, by the network node, a transmission counter associated with the each transmitted downlink transmission of the first set of downlink transmissions, wherein the transmission counter is incremented after each transmitted downlink transmission of the first set of downlink transmissions wherein, optionally, the transmission counter is incremented until it reaches a maximum value and is reset to an initial value at the next increment after the maximum value.
Clause 47. The method of Clause 46 wherein the transmission counter for each of the first set of downlink transmissions is transmitted in a downlink control signal associated with the each of the first set of downlink transmissions.
Clause 48. The method of Clause 46 or 47 wherein the downlink control signal comprises a downlink grant for the each of the first set of downlink transmissions.
Clause 49. The method of any one of Clauses 46 to 48, wherein determining whether the communications device has missed one or more downlink transmissions comprises determining whether the communications device has missed one or more downlink transmissions based on the identification of the any received downlink transmissions associated with an EGI and on the transmission counter.
Clause 50. The method of any one of Clauses 27 to 49, further comprising:
determining, by the network node, a first set of resources for receiving the acknowledgement information for the first set of downlink transmissions based on at least the number of transmissions in the first set of downlink transmissions, and
attempting, by the network node, to receive the acknowledgement information in the first set of resources; and
determining, by the communications device, an expected number of transmissions in the first set of downlink transmissions based on the identification of the any received downlink transmissions associated with an EGI,
determining, by the communications device, a second set of resources for transmitting the acknowledgement information for the first set of downlink transmissions based on at least the expected number of transmissions in the first set of downlink transmissions, and
transmitting, by the communications device, acknowledgement information to the network node using the second set of resources.
Clause 51. The method of any one of Clauses 27 to 50, wherein determining whether the communications device has missed one or more downlink transmissions comprises determining whether the communications device has missed one or more downlink transmissions based on a comparison of a number of identified received downlink transmissions with the number N of downlink transmissions of the first set of downlink transmissions expected to be associated with an EGI.
Clause 52. The method of any one of Clauses 27 to 51, wherein N is configured based on one or more of Radio Resource Control “RRC” signalling to the communications device and a predetermined value.
Clause 53. A system for communicating in a mobile communications network comprising a network node and a communications device, the network node being configured to provide a wireless interface to communicate with the communications device,
wherein the network node is configured to:
identify, in a first set of downlink transmissions to be transmitted to the communications device, the last N downlink transmissions where N is greater than or equal to 1, and
transmit the first set of downlink transmissions to the communications device wherein transmitting the last N downlink transmissions comprises providing an Ending Grant Indicator “EGI” in association with each of the N downlink transmissions; and
wherein the communications device is configured to:
receive downlink transmissions of the first set of downlink transmissions, identify any received downlink transmissions of the first set of downlink transmissions that is associated with an EGI,
determine, based on the identification of the any received downlink transmissions associated with an EGI, whether the communications device has missed one or more downlink transmissions, and
transmit acknowledgement information to the network node based on the determination of whether one or more downlink transmissions have been missed.
Clause 54. The system of Clause 53, the system being configured to implement the method of any of Clauses 27 to 52.
Clause 55. A method of operating a network node in a mobile communications network comprising the network node and a communications device, the network node being configured to provide a wireless interface to communicate with the communications device, wherein method comprises:
identifying, in a first set of downlink transmissions to be transmitted to the communications device, the last N downlink transmissions where N is greater than or equal to 1; and
transmitting the first set of downlink transmissions to the communications device wherein transmitting the last N downlink transmissions comprises providing an Ending Grant Indicator “EGI” in association with each of the N downlink transmissions
Clause 56. The method of Clause 55 wherein providing the EGI in association with each of the N downlink transmissions comprises including an EGI in a downlink control signal associated with the each of the N downlink transmissions.
Clause 57. The method of Clause 56 wherein the downlink control signal comprises a downlink grant for the each of the N downlink transmissions.
Clause 58. The method of any one of Clauses 55 to 57, further comprising transmitting the EGI as a one bit indicator, the one bit indicator being set to a first value for any downlink transmission of the first set of downlink transmissions which is not in the last N downlink transmissions and being set to a second value, different from the first value, for the last N downlink transmissions.
Clause 59. The method of any one of Clauses 55 to 58, further comprising transmitting the EGI as n-bit counter for counting the last N downlink transmissions.
Clause 60. The method of Clause 59 wherein the counter incrementally counts each of the last N downlink transmissions or decrementally counts each of the last N downlink transmissions.
Clause 61. The method of any one of Clauses 55 to 60, wherein providing the EGI comprises configuring a field of a Downlink Control Information “DCI” associated with the first set of downlink transmissions, wherein the field is used to communication a configuration other than an EGI and in respect of transmissions other than the first set of downlink transmissions.
Clause 62. The method of Clause 61 wherein the first set of downlink transmissions is associated with a low priority and wherein the field is used to configure transmissions associated with a high priority.
Clause 63. The method of Clause 61 or 62 wherein the field is a Multiplexing Indicator indicating whether the acknowledgement information for transmissions associated with a high priority will be multiplexed with acknowledgement information for transmissions associated with a low priority.
Clause 64. The method of any one of Clauses 55 to 63, further comprising:
identifying a second set of downlink transmissions to be transmitted to the communications device, and providing the EGI in association with each of the N downlink transmissions when the network node determines that the communications device is configured to multiplex the acknowledgement information for the first set and the acknowledgement information for the second set.
Clause 65. The method of Clause 64, wherein the first set of downlink transmissions is associated with a low priority and the second set of downlink transmissions is associated with a high priority.
Clause 66. The method of any one of Clauses 55 to 65, wherein the first set of downlink transmissions are associated with one of a high priority and a low priority.
Clause 67. The method of any one of Clauses 55 to 66, wherein the first set of downlink transmissions is a first set of downlink transmissions to be acknowledged together in an uplink transmission by the communications device.
Clause 68. The method of any one of Clauses 55 to 67, further comprising transmitting a transmission counter associated with the each transmitted downlink transmission of the first set of downlink transmissions, wherein the transmission counter is incremented after each transmitted downlink transmission of the first set of downlink transmissions wherein, optionally, the transmission counter is incremented until it reaches a maximum value and is reset to an initial value at the next increment after the maximum value.
Clause 69. The method of Clause 68, wherein the transmission counter for each of the first set of downlink transmissions is transmitted in a downlink control signal associated with the each of the first set of downlink transmissions.
Clause 70. The method of Clause 68 or 69, wherein the downlink control signal comprises a downlink grant for the each of the first set of downlink transmissions.
Clause 71. The method of any one of Clauses 55 to 70, wherein N is configured based on one or more of Radio Resource Control “RRC” signalling to the communications device and a predetermined value.
Clause 74. A network node for use in a mobile communications network comprising the network node and a communications device, the network node being configured to provide a wireless interface to communicate with the communications device, wherein the network node is further configured to: identify, in a first set of downlink transmissions to be transmitted to the communications device, the last
N downlink transmissions where N is greater than or equal to 1; and transmit the first set of downlink transmissions to the communications device wherein transmitting the last N downlink transmissions comprises providing an Ending Grant Indicator “EGI” in association with each of the N downlink transmissions.
Clause 75. The network node of Clause 74 being further configured to implement the method of any one of Clauses 55 to 71.
Clause 76. Circuitry for a network node for use in a mobile telecommunications network, the network comprising the network node and a communications device, the network node being configured to provide a wireless interface to communicate with the communications device, wherein the circuitry comprises a controller element and a transceiver element configured to operate together to communicate with the communications device via the wireless interface and wherein the controller element and the transceiver element are further configured to operate together to:
identify, in a first set of downlink transmissions to be transmitted to the communications device, the last N downlink transmissions where N is greater than or equal to 1; and
transmit the first set of downlink transmissions to the communications device wherein transmitting the last N downlink transmissions comprises providing an Ending Grant Indicator “EGI” in association with each of the N downlink transmissions.
Clause 77. A method of operating a communications device for use in a mobile communications network comprising a network node and the communications device, the network node being configured to provide a wireless interface to communicate with the communications device, the method comprising: receiving downlink transmissions of a first set of downlink transmissions;
identifying any received downlink transmissions of the first set of downlink transmissions that is associated with an Ending Grant Indicator “EGI” provided by the network node;
determining, based on the identification of the any received downlink transmissions associated with an EGI, whether the communications device has missed one or more downlink transmissions, and transmitting acknowledgement information to the network node based on the determination of whether one or more downlink transmissions have been missed.
Clause 78. The method of Clause 77 wherein identifying any received downlink transmissions of the first set of downlink transmissions that is associated with an Ending Grant Indicator “EGI” provided by the network node comprises determining whether an EGI is detected in one or more downlink control signals associated with respective one or more of the downlink transmissions.
Clause 79. The method of Clause 78 wherein the downlink control signal comprises a downlink grant for the respective one of the one or more of the downlink transmissions.
Clause 80. The method of any one of Clauses 77 27 to 79, further comprising detecting the EGI as a one bit indicator, the one bit indicator being set to a first value for any downlink transmission of the first set of downlink transmissions which is not in the last N downlink transmissions and being set to a second value, different from the first value, for the last N downlink transmissions.
Clause 81. The method of any one of Clauses 77 to 80, further comprising detecting the EGI as n-bit counter for counting the last N downlink transmissions.
Clause 82. The method of Clause 81 wherein the counter incrementally counts each of the last N downlink transmissions or decrementally counts each of the last N downlink transmissions.
Clause 83. The method of any one of Clauses 77 to 82, wherein the EGI is provided in a field of a Downlink Control Information “DCI” associated with the first set of downlink transmissions, wherein the field is also used to configure transmissions other than the first set of downlink transmissions.
Clause 84. The method of Clause 83 wherein the first set of downlink transmissions is associated with a low priority and wherein the field is used to configure transmissions associated with a high priority.
Clause 85. The method of Clause 83 or 84 wherein the field is a Multiplexing Indicator indicating whether the acknowledgement information for transmissions associated with a high priority will be multiplexed with acknowledgement information for transmissions associated with a low priority.
Clause 86. The method of any one of Clauses 77 to 85, further comprising: Identifying a second set of downlink transmissions to be received from the network node, and wherein identifying the any downlink transmissions of the first set of downlink transmissions that was received in association with an EGI comprises identifying the any downlink transmissions of the first set of downlink transmissions that was received in association with an EGI when the communications device determines that the communications device is configured to multiplex the acknowledgement information for the first set and the acknowledgement information for the second set.
Clause 87. The method of Clause 86, wherein the first set of downlink transmissions is associated with a low priority and the second set of downlink transmissions is associated with a high priority.
Clause 88. The method of any one of Clauses 77 to 87, wherein the first set of downlink transmissions are associated with one of a high priority and a low priority.
Clause 89. The method of any one of Clauses 77 to 88, further comprising attempting, if the communications device determines that the communications device has missed one or more downlink transmissions, to identify a number of downlink transmissions of the first set of downlink transmissions have been missed.
Clause 90. The method of Clause 89 further comprising if the communications device is not able to identify the number of downlink transmissions of the first set of downlink transmissions have been missed, not transmitting acknowledgement information for the first set of downlink transmissions.
Clause 91. The method of any one of Clauses 77 to 90, further comprising, if the identification of the any received downlink transmissions associated with an EGI identifies no received downlink transmissions associated with an EGI, the communications device not transmitting acknowledgement information for the first set of downlink transmissions.
Clause 92. The method of any one of Clauses 77 to 91, further comprising if it determines that the communications device has missed one or more downlink transmissions, estimating how many downlink transmissions of the first set of downlink transmissions have been missed.
Clause 93. The method of Clause 92 wherein estimating how many downlink transmissions of the first set of downlink transmissions have been missed comprises adding a predetermined first number to a number of known transmissions of the first set of downlink transmissions, wherein, optionally, the predetermined first number is equal to N.
Clause 94. The method of any one of Clauses 77 to 93, wherein the first set of downlink transmissions is a first set of downlink transmissions to be acknowledged together in an uplink transmission by the communications device.
Clause 95. The method of any one of Clauses 77 to 45, further comprising receiving a transmission counter associated with the each transmitted downlink transmission of the first set of downlink transmissions, wherein the transmission counter is incremented after each transmitted downlink transmission of the first set of downlink transmissions wherein, optionally, the transmission counter is incremented until it reaches a maximum value and is reset to an initial value at the next increment after the maximum value.
Clause 96. The method of Clause 95 wherein the transmission counter for each of the first set of downlink transmissions is transmitted in a downlink control signal associated with the each of the first set of downlink transmissions.
Clause 97. The method of Clause 95 or 96 wherein the downlink control signal comprises a downlink grant for the each of the first set of downlink transmissions.
Clause 98. The method of any one of Clauses 95 to 97, wherein determining whether the communications device has missed one or more downlink transmissions comprises determining whether the communications device has missed one or more downlink transmissions based on the identification of the any received downlink transmissions associated with an EGI and on the transmission counter.
Clause 99. The method of any one of Clauses 77 to 98, wherein determining whether the communications device has missed one or more downlink transmissions comprises determining whether the communications device has missed one or more downlink transmissions based on a comparison of a number of identified received downlink transmissions with the number N of downlink transmissions of the first set of downlink transmissions expected to be associated with an EGI.
Clause 100. The method of any one of Clauses 77 to 99, wherein N is configured based on one or more of Radio Resource Control “RRC” signalling to the communications device and a predetermined value.
Clause 101. A communications device for use in a mobile communications network comprising a network node and the communications device, the network node being configured to provide a wireless interface to communicate with the communications device, wherein the communications device is configured to:
receive downlink transmissions of a first set of downlink transmissions;
identify any received downlink transmissions of the first set of downlink transmissions that is associated with an Ending Grant Indicator “EGI” provided by the network node;
determine, based on the identification of the any received downlink transmissions associated with an EGI, whether the communications device has missed one or more downlink transmissions, and transmit acknowledgement information to the network node based on the determination of whether one or more downlink transmissions have been missed.
Clause 102. The communications device of Clause 101 wherein the communications device is configured to implement the method of one of Clauses 77 to 100.
Clause 103. Circuitry for a communications device for use in a mobile telecommunications network, the network comprising a network node and the communications device, the network node being configured to provide a wireless interface to communicate with the communications device, wherein the circuitry comprises a controller element and a transceiver element configured to operate together to communicate with the communications device via the wireless interface and wherein the controller element and the transceiver element are further configured to operate together to:
receive downlink transmissions of a first set of downlink transmissions;
identify any received downlink transmissions of the first set of downlink transmissions that is associated with an Ending Grant Indicator “EGI” provided by the network node;
determine, based on the identification of the any received downlink transmissions associated with an EGI, whether the communications device has missed one or more downlink transmissions, and transmit acknowledgement information to the network node based on the determination of whether one or more downlink transmissions have been missed.

### REFERENCES

[1] 3GPP document RP-160671, “New SID Proposal: Study on New Radio Access Technology,” NTT DOCOMO, RAN #71, Gothenburg, Sweden, 7 to 10 Mar. 2016
[2] 3GPP document RP-172834, “Work Item on New Radio (NR) Access Technology,” NTT DOCOMO, RAN #78, Lisbon, Portugal, 18 to 21 Dec. 2017
[3] 3GPP document RP-182089, “New SID on Physical Layer Enhancements for NR Ultra-Reliable and Low Latency Communication (URLLC),” Huawei, HiSilicon, Nokia, Nokia Shanghai Bell, RAN #81, Gold Coast, Australia, 10 to 13 Sep. 2018
[4] 3GPP document RP-190654, “New WID: Physical layer enhancements for NR ultra-reliable and low latency communication (URLLC),” Huawei, HiSilicon, RAN #83, Shenzhen, China, 18 to 21 Mar. 2019
[5] TR38.913, “Study on Scenarios and Requirements for Next Generation Access Technologies (Release 14)”, v14.3.0
[6] RP-190726, “Physical layer enhancements for NR ultra-reliable and low latency communication (URLLC),” Huawei, HiSilicon, RAN #83
[7] RP-193233, “Enhanced Industrial Internet of Things (IoT) and URLLC support,” Nokia, Nokia Shanghai Bell, RAN #86
[8] RP-191575, “NR-based Access to Unlicensed Spectrum,” Qualcomm, RAN #84
[9] Holma H. and Toskala A, “LTE for UMTS OFDMA and SC-FDMA based radio access”, John Wiley and Sons, 2009
[10] EP 20187799.0 filed 24 Jul. 2020 entitled “Mobile nodes, network nodes, circuitry, systems and methods”
[11] R1-2106492, “Intra-UE multiplexing enhancements,” Huawei, HiSilicon, RAN1 #106e
[12] R1-2106637, “On UL intra-UE prioritization and multiplexing enhancements,” Nokia, Nokia Shanghai Bell, RAN1 #106e
[13] R1-2107339, “Intra-UE multiplexing and prioritization for IOT and URLLC,” Qualcomm, RAN1 #106e
[14] R1-2106965, “Intra-UE multiplexing and prioritization,” CATT, RAN1 #106e
[15] R1-2107073, “Intra-UE multiplexing and prioritization,” InterDigital, RAN1 #106e
[16] R1-2106804, “Considerations on UL Intra-UE Multiplexing,” Sony, RAN1 #106e

1. A method for use in a mobile communications network comprising a network node and a communications device, the network node being configured to provide a wireless interface to communicate with the communications device, the method comprising:
identifying, by the network node and in a first set of downlink transmissions to be transmitted to the communications device, the last N downlink transmissions where N is greater than or equal to 1;
transmitting, by the network node, the first set of downlink transmissions to the communications device wherein transmitting the last N downlink transmissions comprises providing an Ending Grant Indicator “EGI” in association with each of the N downlink transmissions:
receiving, by the communications device, downlink transmissions of the first set of downlink transmissions:
identifying, by the communications device, any received downlink transmissions of the first set of downlink transmissions that is associated with an EGI:
determining, by the communications device and based on the identification of the any received downlink transmissions associated with an EGI, whether the communications device has missed one or more downlink transmissions; and
transmitting, by the communications device, acknowledgement information to the network node based on the determination of whether one or more downlink transmissions have been missed.

2. The method of claim 0 wherein the network node providing the EGI in association with each of the N downlink transmissions comprises the network node including an EGI in a downlink control signal associated with the each of the N downlink transmissions, the downlink control signal comprising a downlink grant for the each of the N downlink transmissions.

3. The method of claim 0, further comprising transmitting,
by the network node, the EGI as a one bit indicator, the one bit indicator being set to a first value for any downlink transmission of the first set of downlink transmissions which is not in the last N downlink transmissions and being set to a second value, different from the first value,
for the last N downlink transmissions.

4. The method of claim 1, further comprising transmitting, by the network node, the EGI as n-bit counter for counting the last N downlink transmissions.

5. The method of claim 0 wherein the counter incrementally counts each of the last N downlink transmissions or decrementally counts each of the last N downlink transmissions.

6. The method of claim 1, wherein
providing the EGI comprises configuring a field of a Downlink Control Information “DCI” associated with the first set of downlink transmissions, wherein the field is also used to configure transmissions other than the first set of downlink transmissions.

7. The method of claim 0 wherein the first set of downlink transmissions is associated with a low priority and wherein the field is used to configure transmissions associated with a high priority.

8. The method of claim 0 wherein the field is a Multiplexing Indicator indicating whether the acknowledgement information for transmissions associated with a high priority will be multiplexed with acknowledgement information for transmissions associated with a low priority.

9. The method of claim 1, further comprising:
identifying, by the network node, a second set of downlink transmissions to be transmitted to the communications device,
wherein providing the EGI comprises providing the EGI in association with each of the N downlink transmissions when the network node determines that the communications device is configured to multiplex the acknowledgement information for the first set and the acknowledgement information for the second set.

10. The method of claim 1, further comprising:
identifying, by the communications device, a second set of downlink transmissions to be received from the network node, and
wherein the communications device identifies the any downlink transmissions of the first set of downlink transmissions that was received in association with an EGI when the communications device determines that the communications device is configured to multiplex the acknowledgement information for the first set and the acknowledgement information for the second set.

11. The method of claim 0, wherein the first set of downlink transmissions is associated with a low priority and the second set of downlink transmissions is associated with a high priority.

12. The method of claim 1, further comprising the communications device attempting, if it determines that the communications device has missed one or more downlink transmissions, to identify a number of downlink transmissions of the first set of downlink transmissions have been missed.

13. The method of claim 0 further comprising the communications device,
if the communications device is not able to identify the number of downlink transmissions of the first set of downlink transmissions have been missed, not transmitting acknowledgement information for the first set of downlink transmissions.

14. The method of claim 13, further comprising, if the identification of the any received downlink transmissions associated with an EGI identifies no received downlink transmissions associated with an EGI, the communications device not transmitting acknowledgement information for the first set of downlink transmissions.

15. The method of claim 1, further comprising the communications device, if it determines that the communications device has missed one or more downlink transmissions, estimating how many downlink transmissions of the first set of downlink transmissions have been missed.

16. The method of claim 0 wherein the communications device estimating how many downlink transmissions of the first set of downlink transmissions have been missed comprises the communications device adding a predetermined first number to a number of known transmissions of the first set of downlink transmissions, wherein, optionally, the predetermined first number is equal to N.

17. The method of claim 1, wherein
determining whether the communications device has missed one or more downlink transmissions comprises determining whether the communications device has missed one or more downlink transmissions based on a comparison of a number of identified received downlink transmissions with the number N of downlink transmissions of the first set of downlink transmissions expected to be associated with an EGI.

18. The method of claim 1, wherein N is configured based on one or more of Radio Resource Control “RRC” signalling to the communications device and a predetermined value.

19.-22. (canceled)

23. Circuitry for a network node for use in a mobile telecommunications network,
the network comprising the network node and a communications device, the network node being configured to provide a wireless interface to communicate with the communications device, wherein the circuitry comprises a controller element and a transceiver element configured to operate together to communicate with the communications device via the wireless interface and wherein the controller element and the transceiver element are further configured to operate together to:
identify, in a first set of downlink transmissions to be transmitted to the communications device, the last N downlink transmissions where N is greater than or equal to 1; and
transmit the first set of downlink transmissions to the communications device wherein transmitting the last N downlink transmissions comprises providing an Ending Grant Indicator “EGI” in association with each of the N downlink transmissions.

24.-25. (canceled)

26. Circuitry for a communications device for use in a mobile telecommunications network, the network comprising a network node and the communications device, the network node being configured to provide a wireless interface to communicate with the communications device, wherein the circuitry comprises a controller element and a transceiver element configured to operate together to communicate with the communications device via the wireless interface and wherein the controller element and the transceiver element are further configured to operate together to:
receive downlink transmissions of a first set of downlink transmissions;
identify any received downlink transmissions of the first set of downlink transmissions that is associated with an Ending Grant Indicator “EGI” provided by the network node;
determine, based on the identification of the any received downlink transmissions associated with an EGI, whether the communications device has missed one or more downlink transmissions, and
transmit acknowledgement information to the network node based on the determination of whether one or more downlink transmissions have been missed.
